(19) United States
(12) Patent Application Publication
(10) Pub. No.: US 2025/0220494 A1
(43) Pub. Date: Jul. 3, 2025

(54) EXPLICIT CONGESTION NOTIFICATION ON A WIRELESS NETWORK INTERFACE

(71) Applicant: QUALCOMM Incorporated, San Diego, CA (US)

(72) Inventors: Linhai HE, San Diego, CA (US); Sitaramanjaneyulu KANAMARLAPUDI, San Diego, CA (US)

(21) Appl. No.: 18/397,236

(22) Filed: Dec. 27, 2023

(51) Int. Cl. H04W 28/02

(52) U.S. Cl. CPC H04W 28/0268

(57) ABSTRACT

Various aspects of the present disclosure generally relate to wireless communication. In some aspects, a user equipment (UE) may receive an internet protocol (IP) packet. The UE may identify a quality of service (QOS) flow associated with the IP packet. The UE may detect an uplink explicit congestion notification (ECN) status associated with the QoS flow based at least in part on header information associated with the IP packet. The UE may transmit an indication of the uplink ECN status to a core network entity. The UE may perform one of: marking the IP packet with uplink ECN information based at least in part on uplink ECN criteria, or transmitting, to a radio access network (RAN) network entity, an indication that at least one of the uplink ECN criteria is met or that none of the uplink ECN criteria is met. Numerous other aspects are described.

### FIELD OF THE DISCLOSURE

Aspects of the present disclosure generally relate to wireless communication and to techniques and apparatuses for explicit congestion notification on a wireless network interface.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes one or more memories; and one or more processors, coupled to the one or more memories, configured to: receive an internet protocol (IP) packet; identify a quality of service (QOS) flow associated with the IP packet based at least in part on receiving the IP packet; detect an uplink explicit congestion notification (ECN) status associated with the QoS flow based at least in part on header information associated with the IP packet; transmit an indication of the uplink ECN status to a core network entity based at least in part on the header information associated with the IP packet; and perform one of: mark the IP packet with uplink ECN information based at least in part on uplink ECN criteria, or transmit, to a radio access network (RAN) network entity, an indication that at least one of the uplink ECN criteria is met or that none of the uplink ECN criteria is met.

In some aspects, a core network entity for wireless communication includes one or more memories; and one or more processors, coupled to the one or more memories, configured to: receive, from a UE, an indication of an uplink ECN status associated with a QoS flow associated with an IP packet, wherein the uplink ECN status is based at least in part on header information associated with the IP packet; and transmit, to a RAN network entity, configuration information indicating the uplink ECN status associated with the QoS flow associated with the IP packet.

In some aspects, a method of wireless communication performed by a UE includes receiving an IP packet; identifying a QoS flow associated with the IP packet based at least in part on receiving the IP packet; detecting an uplink ECN status associated with the QoS flow based at least in part on header information associated with the IP packet; transmitting an indication of the uplink ECN status to a core network entity based at least in part on the header information associated with the IP packet; and performing one of: marking the IP packet with uplink ECN information based at least in part on uplink ECN criteria, or transmitting, to a RAN network entity, an indication that at least one of the uplink ECN criteria is met or that none of the uplink ECN criteria is met.

In some aspects, a method of wireless communication performed by a core network entity includes receiving, from a UE, an indication of an uplink ECN status associated with a QoS flow associated with an IP packet, wherein the uplink ECN status is based at least in part on header information associated with the IP packet; and transmitting, to a RAN network entity, configuration information indicating the uplink ECN status associated with the QoS flow associated with the IP packet.

Some aspects described herein relate to a method of wireless communication performed by a UE. The method may include receiving configuration information indicating ECN marking criteria associated with a QoS flow associated with an IP packet. The method may include detecting, based at least in part on the ECN marking criteria, an ECN status associated with the QoS flow. The method may include performing one of: marking the IP packet with ECN information based at least in part on the ECN status, or transmitting an indication of the ECN status to a first network entity.

Some aspects described herein relate to a method of wireless communication performed by network entity. The method may include receiving an indication of an ECN status associated with a QoS flow associated with an IP packet, the ECN status being based at least in part on ECN marking criteria associated with the QoS flow. The method may include marking the IP packet with ECN information based at least in part on the ECN status.

Some aspects described herein relate to a method of wireless communication performed by a network entity. The method may include transmitting configuration information indicating ECN marking criteria associated with a QoS flow associated with IP packet. The method may include receiving an indication of an ECN status associated with the QoS flow based at least in part on the ECN criteria.

Some aspects described herein relate to a UE for wireless communication. The UE may include one or more memories and one or more processors coupled to the one or more memories. The one or more processors may be configured to receive configuration information indicating ECN marking criteria associated with a QoS flow associated with an IP packet. The one or more processors may be configured to detect, based at least in part on the ECN marking criteria, an ECN status associated with the QoS flow. The one or more processors may be configured to perform one of: mark the IP packet with ECN information based at least in part on the ECN status, or transmit an indication of the ECN status to a first network entity.

Some aspects described herein relate to a network entity for wireless communication. The network entity may include one or more memories and one or more processors coupled to the one or more memories. The one or more processors may be configured to receive an indication of an ECN status associated with a QoS flow associated with an IP packet, the ECN status being based at least in part on ECN marking criteria associated with the QoS flow. The one or more processors may be configured to mark the IP packet with ECN information based at least in part on the ECN status.

Some aspects described herein relate to a network entity for wireless communication. The network entity may include one or more memories and one or more processors coupled to the one or more memories. The one or more processors may be configured to transmit configuration information indicating ECN marking criteria associated with a QoS flow associated with an IP packet. The one or more processors may be configured to receive an indication of an ECN status associated with the QoS flow based at least in part on the ECN criteria.

Some aspects described herein relate to a non-transitory computer-readable medium that stores a set of instructions for wireless communication by a UE. The set of instructions, when executed by one or more processors of the UE, may cause the UE to receive configuration information indicating ECN marking criteria associated with a QoS flow associated with an IP packet. The set of instructions, when executed by one or more processors of the UE, may cause the UE to detect, based at least in part on the ECN marking criteria, an ECN status associated with the QoS flow. The set of instructions, when executed by one or more processors of the UE, may cause the UE to perform one of: mark the IP packet with ECN information based at least in part on the ECN status, or transmit an indication of the ECN status to a first network entity.

Some aspects described herein relate to a non-transitory computer-readable medium that stores a set of instructions for wireless communication by a network entity. The set of instructions, when executed by one or more processors of the network entity, may cause the network entity to receive an indication of an ECN status associated with a QoS flow associated with an IP packet, the ECN status being based at least in part on ECN marking criteria associated with the QoS flow. The set of instructions, when executed by one or more processors of the network entity, may cause the network entity to mark the IP packet with ECN information based at least in part on the ECN status.

Some aspects described herein relate to a non-transitory computer-readable medium that stores a set of instructions for wireless communication by a network entity. The set of instructions, when executed by one or more processors of the network entity, may cause the network entity to transmit configuration information indicating ECN marking criteria associated with a QoS flow associated with an IP packet. The set of instructions, when executed by one or more processors of the network entity, may cause the network entity to receive an indication of an ECN status associated with the QoS flow based at least in part on the ECN criteria.

Some aspects described herein relate to an apparatus for wireless communication. The apparatus may include means for receiving configuration information indicating ECN marking criteria associated with a QoS flow associated IP packet. The apparatus may include means for detecting, based at least in part on the ECN marking criteria, an ECN status associated with the QoS flow. The apparatus may include means for performing one of, means for marking the IP packet with ECN information based at least in part on the ECN status, or means for transmitting an indication of the ECN status to a network entity.

Some aspects described herein relate to an apparatus for wireless communication. The apparatus may include means for receiving an indication of an ECN status associated with a QoS flow associated with an IP packet, the ECN status being based at least in part on ECN marking criteria associated with the QoS flow. The apparatus may include means for marking the IP packet with ECN information based at least in part on the ECN status.

Some aspects described herein relate to an apparatus for wireless communication. The apparatus may include means for transmitting configuration information indicating ECN marking criteria associated with a QoS flow associated with an IP packet. The apparatus may include means for receiving an indication of an ECN status associated with the QoS flow based at least in part on the ECN criteria.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a protocol data unit session for handling various quality of service flows, in accordance with the present disclosure.

FIGS. 5A-5B are diagrams of an example associated with explicit congestion notification (ECN) on a wireless network interface, in accordance with the present disclosure.

FIG. 6 is a diagram illustrating an example process performed, for example, by a UE, in accordance with the present disclosure.

FIG. 7 is a diagram illustrating an example process performed, for example, by a network entity, in accordance with the present disclosure.

FIG. 8 is a diagram illustrating an example process performed, for example, by a network entity, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

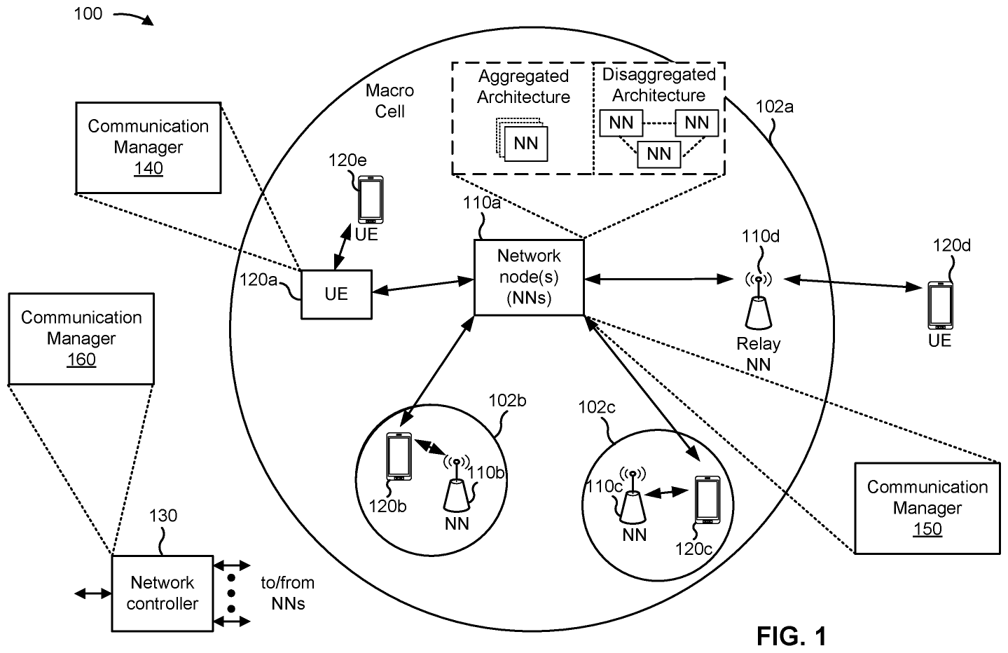

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating explicit congestion notification (ECN) marking criteria associated with a quality of service (QOS) flow associated with an internet protocol (IP) packet; detect, based at least in part on the ECN marking criteria, an ECN status associated with the QoS flow; and perform one of: mark the IP packet with ECN information based at least in part on the ECN status, or transmit an indication of the ECN status to a network node. In some aspects, the communication manager 140 may receive an IP packet; identify a QoS flow associated with the IP packet based at least in part on receiving the IP packet; detect an uplink ECN status associated with the QoS flow based at least in part on header information associated with the IP packet; transmit an indication of the uplink ECN status to a core network entity based at least in part on the header information associated with the IP packet; and perform one of: mark the IP packet with uplink ECN information based at least in part on uplink ECN criteria, or transmit, to a radio access network (RAN) network entity, an indication that at least one of the uplink ECN criteria is met or that none of the uplink ECN criteria is met. Additionally, or alternatively, the communication manager 140 may perform one or more other operations described herein.

In some aspects, the network node 110 may include a communication manager 150. As described in more detail elsewhere herein, the communication manager 150 may receive an indication of an ECN status associated with a QoS flow associated with an IP packet, the ECN status being based at least in part on ECN marking criteria associated with the QoS flow; and mark the IP packet with ECN information based at least in part on the ECN status. Additionally, or alternatively, the communication manager 150 may perform one or more other operations described herein.

In some aspects, the network controller 130 may include a communication manager 160. As described in more detail elsewhere herein, the communication manager 160 may transmit configuration information indicating ECN marking criteria associated with a QoS flow associated with an IP packet; and receive an indication of an ECN status associated with the QoS flow based at least in part on the ECN criteria. In some aspects, the communication manager 160 may receive, from a UE, an indication of an uplink ECN status associated with a QoS flow associated with an IP packet, wherein the uplink ECN status is based at least in part on header information associated with the IP packet; and transmit, to a RAN network entity, configuration information indicating the uplink ECN status associated with the QoS flow associated with the IP packet. Additionally, or alternatively, the communication manager 160 may perform one or more other operations described herein.

As indicated above, FIG. 1 is provided as an example. Other examples may differ from what is described with regard to FIG. 1.

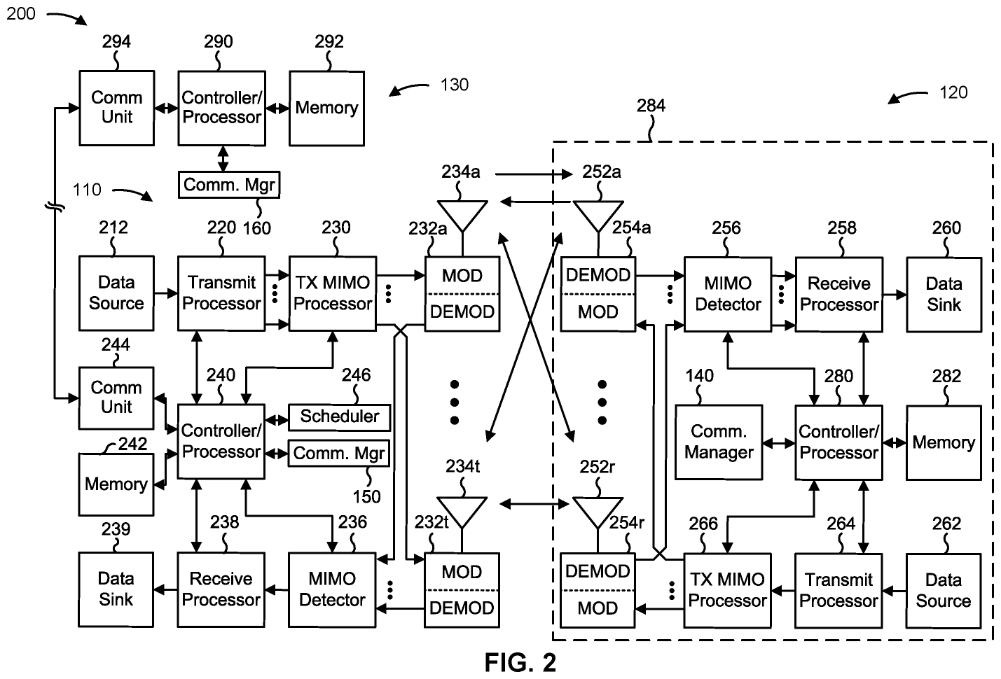

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

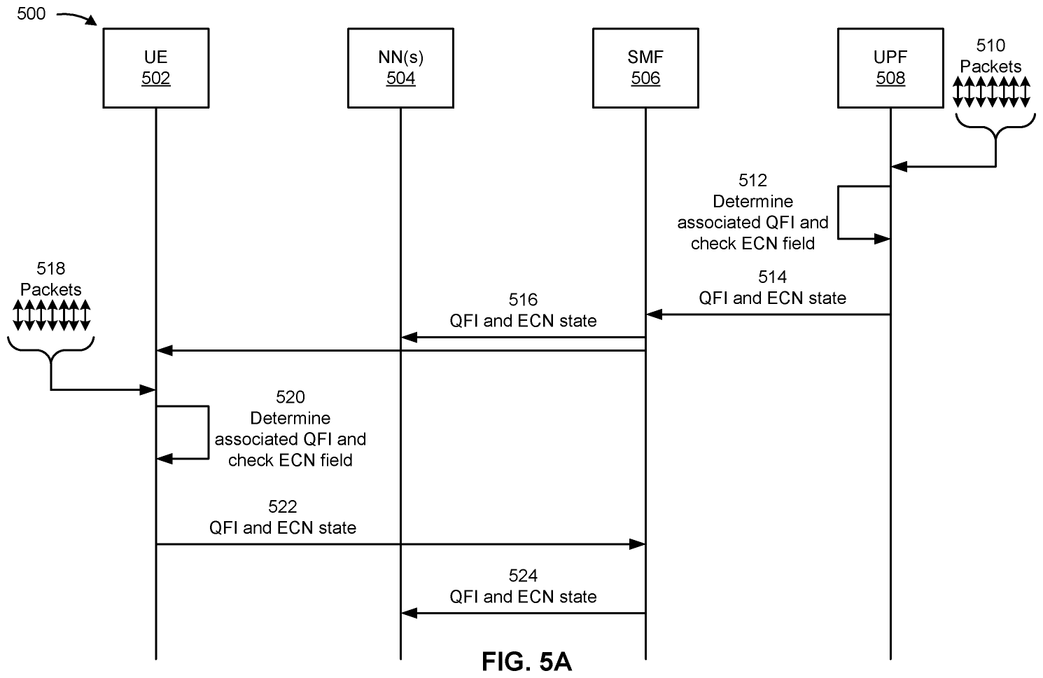

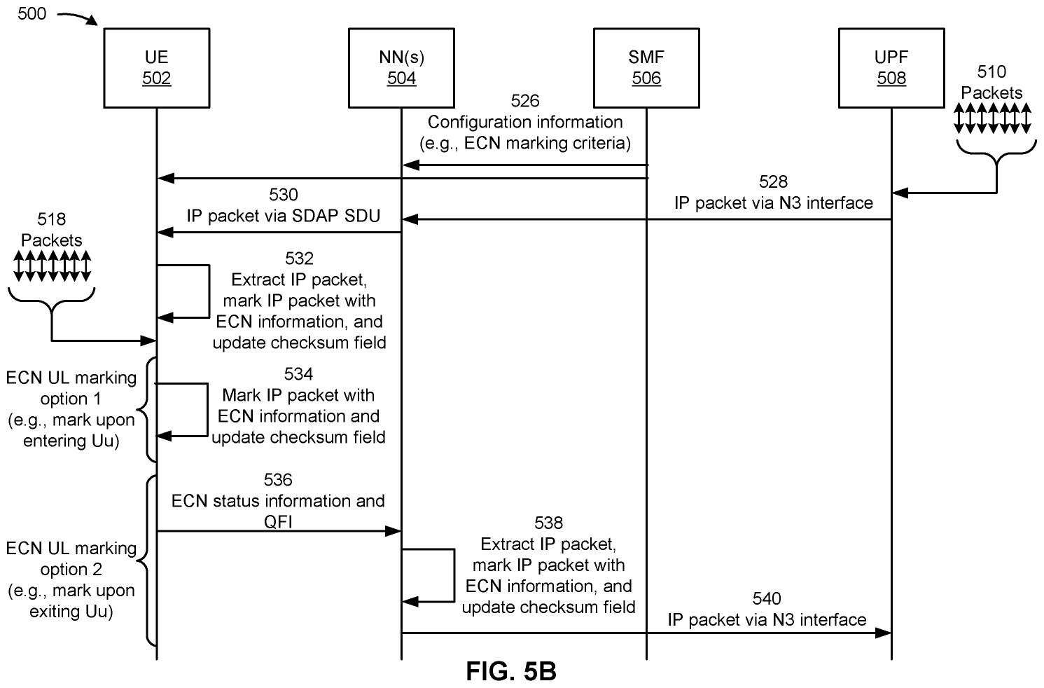

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-11).

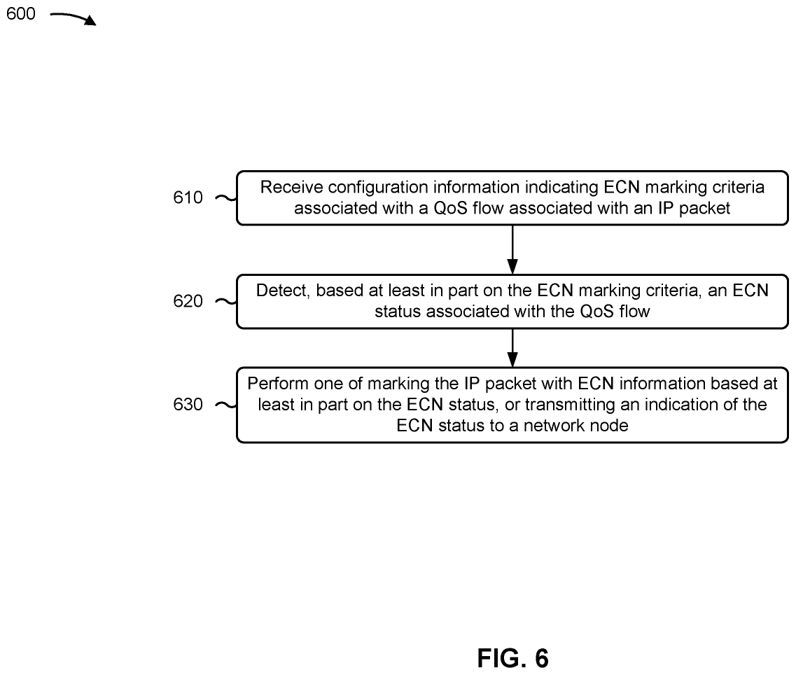

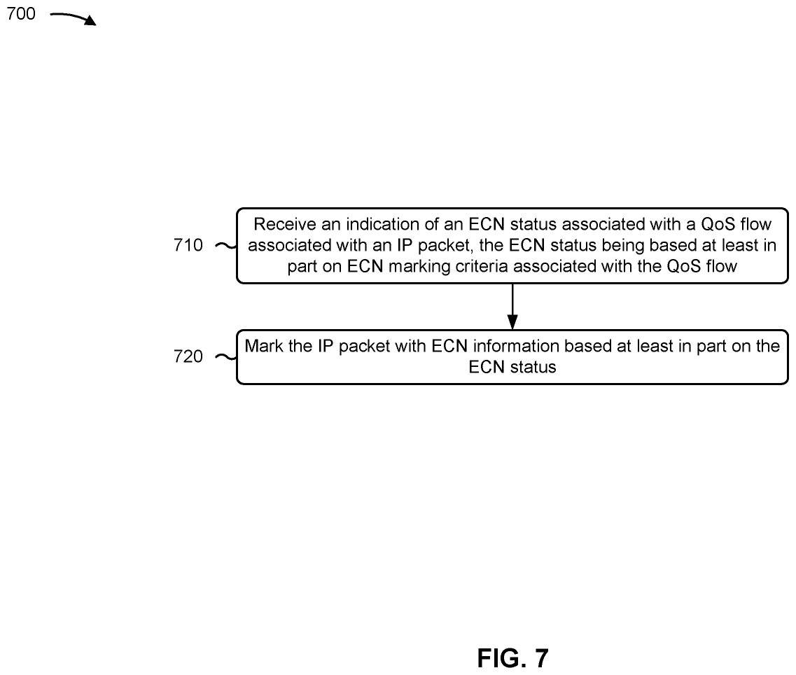

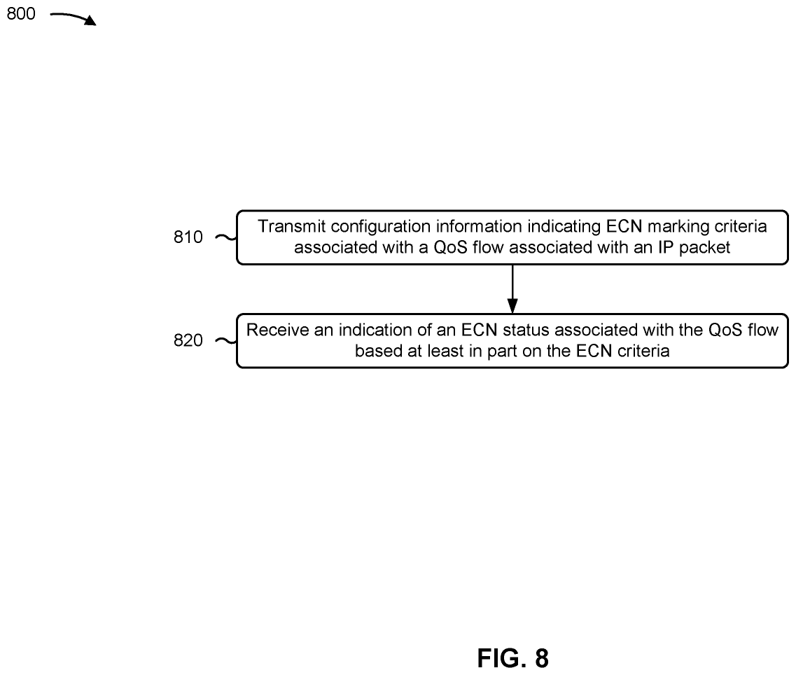

The controller/processor 240 of the network node 110, the controller/processor 280 of the UE 120, and/or any other component(s) of FIG. 2 may perform one or more techniques associated with an explicit congestion notification on a wireless network interface, as described in more detail elsewhere herein. In some aspects, the network entities described herein correspond to the network node 110 and/or the network controller 130, are included in the network node 110 and/or the network controller 130, or include one or more components of the network node 110 and/or the network controller 130 shown in FIG. 2. The controller/processor 240 of the network node 110, the controller/processor 280 of the UE 120, the controller/processor 290 of the network controller 130, and/or any other component(s) of FIG. 2 may perform or direct operations of, for example, process 600 of FIG. 6, process 700 of FIG. 7, process 800 of FIG. 8, and/or other processes as described herein. The memory 242, the memory 282, and the memory 292 may store data and program codes for the network node 110, the UE 120, and the network controller 130, respectively. In some examples, the memory 242, the memory 282, and/or the memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110, the UE 120, and/or the network controller 130, may cause the one or more processors, the UE 120, the network node 110, and/or the network controller 130 to perform or direct operations of, for example, process 600 of FIG. 6, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving configuration information indicating ECN marking criteria associated with a QoS flow associated with an IP packet; means for detecting, based at least in part on the ECN marking criteria, an ECN status associated with the QoS flow; and/or means for performing one of: marking the IP packet with ECN information based at least in part on the ECN status, or transmitting an indication of the ECN status to a network node. In some aspects, the UE 120 includes means for receiving an IP packet; means for identifying a QoS flow associated with the IP packet based at least in part on receiving the IP packet; means for detecting an uplink ECN status associated with the QoS flow based at least in part on header information associated with the IP packet; means for transmitting an indication of the uplink ECN status to a core network entity based at least in part on the header information associated with the IP packet; and/or means for performing one of: marking the IP packet with uplink ECN information based at least in part on uplink ECN criteria, or transmitting, to a RAN network entity, an indication that at least one of the uplink ECN criteria is met or that none of the uplink ECN criteria is met. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the network node 110) includes means for receiving an indication of an ECN status associated with a QoS flow associated with an IP packet, the ECN status being based at least in part on ECN marking criteria associated with the QoS flow; and/or means for marking the IP packet with ECN information based at least in part on the ECN status. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network entity (e.g., network controller 130) includes means for transmitting configuration information indicating ECN marking criteria associated with a QoS flow associated with an IP packet; and/or means for receiving an indication of an ECN status associated with the QoS flow based at least in part on the ECN criteria. In some aspects, the network entity includes means for receiving, from a UE, an indication of an uplink ECN status associated with a QoS flow associated with an IP packet, wherein the uplink ECN status is based at least in part on header information associated with the IP packet; and/or means for transmitting, to a RAN network entity, configuration information indicating the uplink ECN status associated with the QoS flow associated with the IP packet. In some aspects, the means for the network entity to perform operations described herein may include, for example, one or more of communication manager 160, controller/processor 290, memory 292, or communication unit 294.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

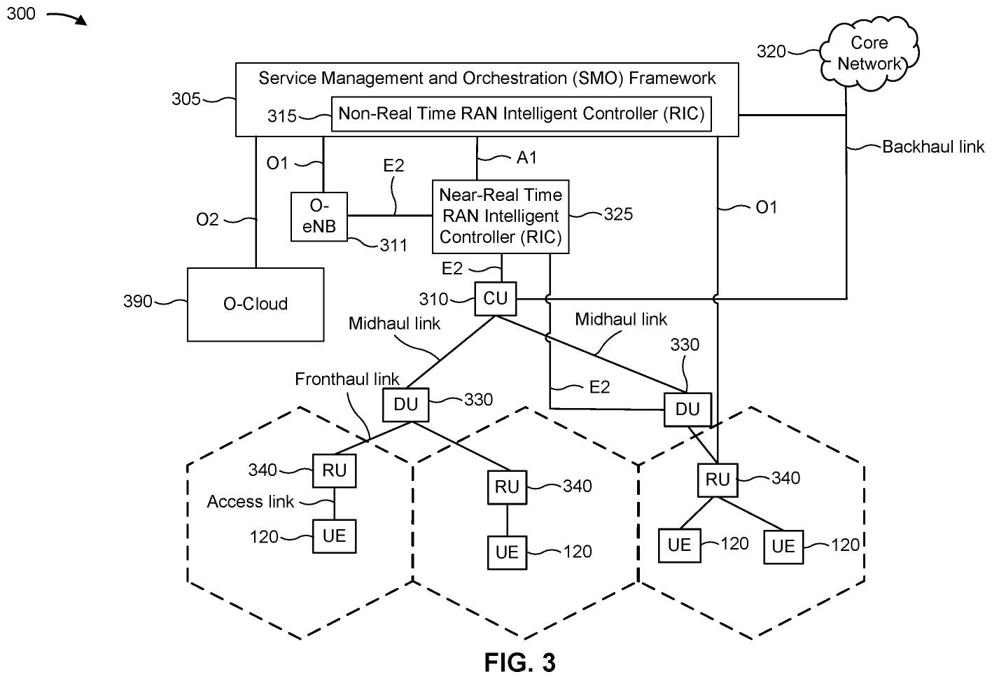

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

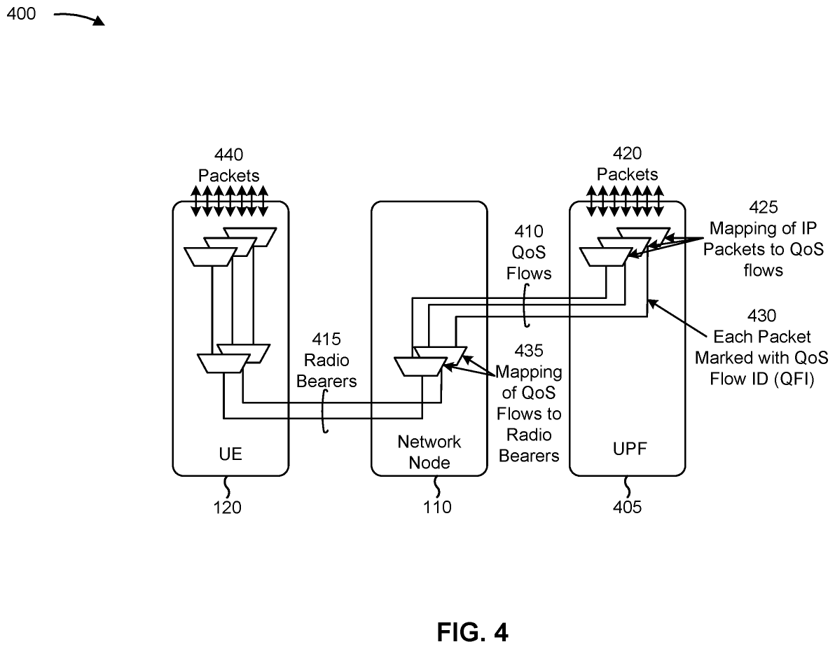

FIG. 4 is a diagram illustrating an example 400 of a protocol data unit (PDU) session for handling various QoS flows, in accordance with the present disclosure. As shown in FIG. 4, a UE 120, a network node 110, and a user plane function (UPF) 405 of a core network may communicate with each other using one or more QoS flows 410 and one or more radio bearers 415. Although shown as an integral unit for ease of description, in some aspects (e.g., in aspects implementing an O-RAN architecture), the network node 110 may be disaggregated, as described above in connection with FIG. 3.

The example PDU session shown in FIG. 4 may be established when the UE 120 connects to a wireless network (e.g., the wireless network 100) via the network node 110. The PDU session may be established for purposes of handling multiple QoS flows, with all traffic within a given QoS flow receiving the same forwarding treatment. For example, time-sensitive communications may be associated with a relatively high QoS priority, and thus may be mapped to a QoS flow associated with a relatively low packet delay budget (PDB) or similar QoS parameters such that the communications are forwarded largely uninterrupted. Other communications, however, which are not as time sensitive, may be associated with a relatively low QoS priority, and thus may be mapped to a QoS flow having a relatively high PDB and similar QoS parameters.

As shown by reference number 420, data packets or the like may be received at the UPF or a similar network controller. As shown by reference number 425, the UPF may map the packets to one of multiple QoS flows 410 according to a QoS priority or the like. The UPF may map the packets to the QoS flows according to certain QoS requirements, such as maximum permissible delay, required data rate, or similar requirement. For example, the most time-sensitive packets may be mapped to a first QoS flow 410 that is associated with a relatively low PDB, a relatively high data rate, or a similar parameter; packets that are less time-sensitive may be mapped to a second QoS flow 410 that is associated with a greater PDB and/or a lower data rate or similar parameter; packets that are even less time-sensitive may be mapped to a third QoS flow 410 that is associated with an even greater PDB and/or an even lower data rate or similar parameter, and so forth. As shown by reference number 430, each packet may also be marked with a QoS flow identifier (QFI, sometimes referred to as a 5QI value) associated with the corresponding QoS flow 410 to assist QoS handling by the network node 110, the UE 102, and/or other network components.

As shown at reference number 435, the network node 110 may receive the packets via the various QoS flows 410 and map each packet to a corresponding radio bearer 415, which may be a signaling radio bearer (SRB) or a data radio bearer (DRB). More particularly, in some aspects an SDAP layer of the network node 110 may map packets a corresponding radio bearers 415. In some aspects, more than one QoS flow 410 may be mapped to a single radio bearer 415. That is, there may not be a one-to-one correlation between the QoS flows 410 and the radio bearers 415. The UE 120 receives the packets via the radio bearers.

In the uplink (e.g., when sending a transmission from the UE 120 to the network node 110 and ultimately to the core network (e.g., the UPF 405)), the above process is generally performed in reverse. More particularly, as shown by reference number 440, the UE 120 may map packets to be transmitted to QoS flows 410 and/or radio bearers 415. More particularly, in some aspects an SDAP layer of the UE 120 may map packets to be transmitted to QoS flows 410 and/or radio bearers 415. In some aspects, the UE 120 (e.g., an SDAP layer of the UE 120) may determine which QoS flow and/or radio bearer to use based at least in part on observing the various QFIs in downlink packets for the PDU session, which provides the UE 120 with information about which packets should be mapped to particular QoS flows and/or radio bearers. In some other aspects, the UE 120 may receive a configuration from the network indicating which QoS flow and/or radio bearer to use for certain packet types, which may be received via RRC signaling or the like. The packets are then transmitted to the network node 110 via the radio bearers 415, and to the UPF 405 via the QoS flows 410, generally in reverse to the process described above.

In some examples, the packets shown in connection with reference numbers 420 and/or 440 may be associated with an IP, and thus may be referred to as IP packets. Additionally, or alternatively, in some examples, the packets shown in connection with reference numbers 420 and/or 440 may be referred to as PDUs and/or network PDU (NPDUs). A packet may refer to an information unit transmitted accordingly to a packet-based transmission protocol (e.g., IP).

Moreover, in some cases, the packets shown in connection with reference numbers 420 and/or 440 may be associated with a congestion notification, such as an ECN. An ECN scheme may allow end-to-end notification of network congestion without dropping packets. In some cases, an ECN scheme may be used between two ECN-enabled endpoints when the underlying network infrastructure (e.g., when a link between the two ECN-enabled endpoints) supports ECN, sometimes referred to as an ECN capable link. Unlike infrastructures that signal network congestion by dropping packets, for ECN schemes an ECN-aware entity (e.g., an ECN-aware router) may mark a header of a packet (e.g., may mark an ECN field of an IP header) instead of dropping a packet in order to signal impending congestion. In some cases, a receiver of the packet may echo the congestion indication to the sender, which thus reduces its transmission rate as if it detected a dropped packet.

In some cases, ECN may employ a two-bit field (sometimes referred to as an ECN field) in a header (e.g., an IP header) to signal one of four codepoints used to convey a congestion state of a network path between ECN-enabled endpoints. More particularly, a codepoint of “01” or “10” may be set by a sender to indicate the sender's capability of supporting ECN. A codepoint of “00” may be a default codepoint, and may indicate that an ECN field has not been marked (e.g., codepoint “00” may be used to indicate that no congestion has been experienced by a packet so far). A codepoint of “11” may be set by an ECN-aware entity (e.g., an ECN-aware router) to indicate congestion in the entity's queue. In some cases, once an ECN field is set to codepoint “11,” the ECN field may not be modified.

For certain communications, a wireless network interface (e.g., an interface associated with the wireless network 100, such as a Uu interface, an interface associated with the example PDU session shown in FIG. 4, and/or a similar interface) may be a bottleneck in an end-to-end connection. Accordingly, congestion and degradation of link quality may take place on the wireless network interface. However, the wireless network interface and/or network entities associated with the wireless network interface (e.g., the UE 120, the network node 110, the UPF 405, or similar network entities) may not support ECN and/or may not be ECN capable. Accordingly, communications occurring on a wireless network interface may not be able to utilize an ECN scheme, resulting in dropped packets and thus degraded link quality. This may result in poor communication performance, such as high latency, low throughput, and even radio link failure, as well high power, computing, and network resource consumption used for purposes of correcting communication errors.

Some techniques and apparatuses described herein enable ECN marking on a wireless network interface (e.g., a Uu interface), such as for downlink and/or uplink transmissions on the wireless network interface. Additionally, or alternatively, some techniques and apparatuses described herein enable signaling and procedures for implementing ECN schemes to indicate congestion on a wireless network interface (e.g., a Uu interface). In some aspects, a UE may receive (e.g., from a session management function (SMF) of a core network, or a similar network entity) ECN marking criteria associated with a QoS flow associated with an IP packet, and the UE may detect, based at least in part on the ECN marking criteria, an ECN status associated with the QoS flow. Based at least in part on the ECN status (e.g., whether congestion has been experienced), the UE may either mark the IP packet with ECN information when the packet enters the wireless network interface (e.g., the Uu interface), or else may transmit an indication of the ECN status to a network node, so that the network node may mark the IP packet with ECN information as the packet exits the wireless network interface. As a result, communications occurring on a wireless network interface may realize a reduction in dropped packets and improved link quality. The techniques and apparatuses described herein may thus result in improved communication performance, such as reduced latency, increased throughput, and reduction in radio link failure. The techniques and apparatuses described herein may also result in reduced power, computing, and network resource consumption that would otherwise be consumed for purposes of correcting communication errors.

As indicated above, FIG. 4 is provided as an example. Other examples may differ from what is described with regard to FIG. 4.

FIGS. 5A-5B are diagrams of an example 500 associated with explicit congestion notification on a wireless network interface, in accordance with the present disclosure. As shown in FIGS. 5A-5B, a UE 502 (e.g., UE 120), a network node 504 (e.g., network node 110, which is sometimes referred to herein as a RAN network entity), an SMF entity 506 (sometimes referred to herein as a core network entity, and/or which may correspond to the network controller 130), and/or a UPF entity 508 (e.g., UPF 405, which similarly is sometimes referred to herein as a core network entity, and/or which may correspond to the network controller 130) may communicate with one another. In some aspects, one or more of the UE 502, the network node 504 (e.g., a RAN network entity), the SMF entity 506 (e.g., a core network entity), and/or the UPF entity 508 (e.g., another core network entity) may be co-located and/or associated with the same device, such as a core network device (e.g., network controller 130). For example, in some aspects, the SMF entity 506 and the UPF entity 508 may be associated with the same core network device. In some aspects, the UE 502, the network node 504, the SMF entity 506, and/or the UPF entity 508 may be part of a wireless network (e.g., wireless network 100). The UE 502, the network node 504, the SMF entity 506, and/or the UPF entity 508 may have established a wireless connection prior to operations shown in FIG. 5A-5B.

FIG. 5A shows procedures and/or signaling associated with enabling ECN marking on a wireless network interface, such as on the Uu interface or a similar wireless network interface. More particularly, the procedures and/or signaling shown in connection with FIG. 5A may be associated with indicating to one or more entities (e.g., the UE 502 and/or the network node 504) whether an end application associated with an IP packet supports ECN.

First, the operations shown in connection with reference numbers 510-516 may be associated with downlink procedures and/or signaling for enabling ECN marking on a wireless network interface. In such aspects, and as shown by reference number 510, a flow of one or more packets (e.g., one or more IP packets, which may correspond to one or more of the packets described in connection with reference number 420) may arrive at a core network device, such as the UPF entity 508. Put another way, as shown by reference number 510, the UPF entity 508 may receive (e.g., using communication manager 160, controller/processor 290, memory 292, communication unit 294, and/or reception component 1102) a flow of one or more IP packets.

As shown by reference number 512, upon receiving the IP packets, the UPF entity 508 (or a similar network entity) may determine (e.g., using communication manager 160 and/or controller/processor 290) a QFI associated an with an IP packet. More particularly, the UPF entity 508 may determine a QoS flow that is associated with the IP packet. Additionally, or alternatively, in the operations shown in connection with reference number 512, the UPF entity 508 may check an ECN field in the header of the IP packet. As described in connection with FIG. 4, an ECN field may be a two-bit field in the IP header that signals one of four codepoints used to convey a congestion state of a network path between ECN-enabled endpoints. For example, a codepoint of “01” or “10” may be set by a sender (e.g., application) to indicate the sender's capability of supporting ECN. A codepoint of “00” may be a default codepoint, and may indicate that an ECN field has not been marked (e.g., codepoint “00” may be used to indicate that no congestion has been experienced by a packet so far). And a codepoint of “11” may be set by an ECN-aware entity (e.g., an ECN-aware router) to indicate congestion in the entity's queue. Accordingly, the UPF entity 508 may check the ECN field to determine if the application that sent the IP packet is ECN capable, such as by checking to see if the sender marked the IP header with a codepoint of “01” or “10” in the ECN field.

As shown by reference number 514, in some aspects, the UPF entity 508 may transmit (e.g., using communication manager 160, controller/processor 290, memory 292, communication unit 294, and/or transmission component 1104), and the SMF entity 506 may receive (e.g., using communication manager 160, controller/processor 290, memory 292, communication unit 294, and/or reception component 1102), an indication of a QFI (e.g., a QFI corresponding to the QoS flow associated with the IP packet) and a corresponding ECN state (e.g., whether the QoS flow and/or endpoints associated with the QoS flow and/or the IP packet are ECN capable). For example, when an IP flow (e.g., a number of IP packets, such as the packets described in connection with reference number 510) is received by the UPF entity 508 for the first time and the endpoints are ECN capable, the UPF entity 508 may transmit the indication shown by reference number 514 to the SMF entity 506 to indicate that the QoS flow (which may be identified by the corresponding QFI) is an ECN-capable QoS flow.

Additionally, or alternatively, if the UPF entity receives an IP packet with an ECN capability indication (e.g., codepoint) set differently from a value previously received, then the UPF entity 508 may transmit the indication shown by reference number 514 to the SMF entity 506 to indicate to the SMF entity 506 that the ECN capability of the QoS flow has changed. For example, if an ECN capability indication associated with a first IP packet of an IP flow indicates that the IP flow is ECN capable, but an ECN capability indication associated with a second IP packet of an IP flow indicates that the IP flow is not ECN capable, the UPF entity 508 may transmit the indication shown by reference number 514 in order to inform the SMF entity 506 that the ECN capability has changed from capable to incapable. Similarly, if an ECN capability indication associated with a first IP packet of an IP flow indicates that the IP flow is not ECN capable, but an ECN capability indication associated with a second IP packet of an IP flow indicates that the IP flow is ECN capable, the UPF entity 508 may transmit the indication shown by reference number 514 in order to inform the SMF entity 506 that the ECN capability has changed from incapable to capable.

As shown by reference number 516, the SMF entity 506 may then configure one or more wireless communication devices with the latest ECN state associated with the QoS flow. More particularly, in some aspects, the SMF entity 506 (e.g., a core network entity) may transmit (e.g., using communication manager 160, controller/processor 290, memory 292, communication unit 294, transmission component 1104, and/or configuration component 1108), and the UE 502 and/or the network node 504 (e.g., a RAN network entity) may receive (e.g., using communication manager 140, controller/processor 280, one or more antennas 252, one or more modems 254, MIMO detector 256, receive processor 258, and/or memory 282 associated with the UE 502, and/or communication manager 150, communication unit 244, controller/processor 240, one or more antennas 234, one or more modems 232, MIMO detector 236, receive processor 238, and/or memory 242 associated with the network node 504), an indication of a QFI (e.g., a QFI corresponding to the QoS flow associated with the IP packet) and a corresponding ECN state (e.g., whether the QoS flow and/or endpoints associated with the QoS flow and/or the IP packet are ECN capable). Put another way, in some aspects, the SMF entity 506 (e.g., a core network entity) may transmit, and the UE 502 and/or the network node 504 (e.g., a RAN network entity) may receive, configuration information indicating that the QoS flow is ECN capable, and/or that an ECN capability of the QoS flow has changed (e.g., from capable to incapable, or from incapable to capable). More particularly, in aspects in which the QoS flow is ECN capable, the SMF entity 506 may configure the UE 502 and/or the network node 504 for ECN marking (which is described in more detail in connection with FIG. 5B). Similarly, in aspects in which the QoS flow has changed from ECN capable to ECN incapable, the SMF entity 506 may de-configure the UE 502 and/or the network node 504 for ECN marking.

Although the operations shown and described in connection with reference numbers 510-516 are associated with downlink procedures and/or signaling for enabling ECN marking, in some other aspects, uplink procedures and/or signaling may be implemented to enable ECN marking on a wireless network interface. More particularly, the operations shown in connection with reference numbers 518-524 may be associated with uplink procedures and/or signaling for enabling ECN marking on a wireless network interface.

More particularly, as shown by reference number 518, a flow of one or more packets (e.g., one or more IP packets, which may correspond to one or more of the packets described in connection with reference number 440) may arrive at the UE 502. Put another way, as shown by reference number 518, the UE 502 may receive (e.g., using communication manager 140, controller/processor 280, one or more antennas 252, one or more modems 254, MIMO detector 256, receive processor 258, memory 282, and/or reception component 902) a flow of one or more IP packets. Moreover, as shown by reference number 520, the UE 502 may determine (e.g., using communication manager 140 and/or controller/processor 280) a QFI associated with an IP packet. More particularly, the UE 502 may determine a QoS flow that is associated with the IP packet. Additionally, or alternatively, in connection with the operations indicated by reference number 520, the UE 502 may check an ECN field in the header of the IP packet. For example, the UE 502 may check the ECN field to determine if the application that sent the IP packet is ECN capable, such as by checking to see if the sender marked the IP header with a codepoint of “01” or “10” in the ECN field. Put another way, in some aspects, the UE 502 may identify a QoS flow associated with the IP packet based at least in part on receiving the IP packet, and/or the UE 502 may detect an ECN status associated with the QoS flow based at least in part on header information associated with the IP packet.

As shown by reference number 522, the UE 502 may transmit (e.g., using communication manager 140, controller/processor 280, one or more antennas 252, one or more modems 254, transmit MIMO processor 266, transmit processor 264, memory 282, and/or transmission component 904), and the SMF entity 506 (e.g., a core network entity) may receive (e.g., using communication manager 160, controller/processor 290, memory 292, communication unit 294, and/or reception component 1102), an indication of the ECN status based at least in part on the header information associated with the IP packet. For example, the UE 502 may transmit the indication of the ECN status to the SMF entity 506 via non-access stratum (NAS) signaling. In some aspects, the signaling shown in connection with reference number 522 may include an indication of a QFI (e.g., a QFI corresponding to the QoS flow associated with the IP packet) and a corresponding ECN state (e.g., whether the QoS flow and/or endpoints associated with the QoS flow and/or the IP packet are ECN capable). For example, when an IP flow (e.g., a number of IP packets, such as the packets shown by reference number 518) is received by the UE 502 for the first time and the endpoints are ECN capable, the UE 502 may transmit the indication shown by reference number 522 to the SMF entity 506 to indicate to the SMF entity 506 that the QoS flow (identified by the corresponding QFI) is an ECN-capable QoS flow.

Additionally, or alternatively, if the UE 502 receives an IP packet with an ECN capability indication (e.g., codepoint) set differently from a value previously received, then the UE 502 may transmit the indication shown by reference number 522 to the SMF entity 506 to indicate to the SMF entity 506 (e.g., a core network entity) that the ECN capability of the QoS flow has changed. For example, if an ECN capability indication (e.g., an ECN field) associated with a first IP packet of an IP flow indicates that the IP flow is ECN capable, but an ECN capability indication associated with a second IP packet of an IP flow indicates that the IP flow is not ECN capable, the UE 502 may transmit the indication shown by reference number 522 in order to inform the SMF entity 506 that the ECN capability has changed from capable to incapable. Similarly, if an ECN capability indication associated with a first IP packet of an IP flow indicates that the IP flow is not ECN capable, but an ECN capability indication associated with a second IP packet of an IP flow indicates that the IP flow is ECN capable, the UE 502 may transmit the indication shown by reference number 522 in order to inform the SMF entity 506 that the ECN capability has changed from incapable to capable. In this way, the UE 502 may transmit the indication of the ECN status to the SMF entity 506 (e.g., a core network entity) based at least in part the UE 502 identifying that the QoS flow is ECN capable, and/or the UE 502 identifying that an ECN capability of the QoS flow has changed.

As shown by reference number 524, the SMF entity 506 may then configure one or more wireless communication devices with the latest ECN state associated with the QoS flow. More particularly, in some aspects, the SMF entity 506 (e.g., a core network entity) may transmit (e.g., using communication manager 160, controller/processor 290, memory 292, communication unit 294, transmission component 1104, and/or configuration component 1108), and the network node 504 (e.g., a RAN network entity) may receive (e.g., using communication manager 150, communication unit 244, controller/processor 240, one or more antennas 234, one or more modems 232, MIMO detector 236, receive processor 238, memory 242, and/or reception component 1002), an indication of a QFI (e.g., a QFI corresponding to the QoS flow associated with the IP packet) and a corresponding ECN state (e.g., whether the QoS flow and/or endpoints associated with the QoS flow and/or the IP packet are ECN capable). Put another way, in some aspects, the SMF entity 506 (e.g., a core network entity) may transmit, and the network node 504 (e.g., a RAN network entity) may receive, configuration information indicating that the QoS flow is ECN capable, and/or that an ECN capability of the QoS flow has changed (e.g., from capable to incapable, or from incapable to capable). More particularly, in aspects in which the QoS flow is ECN capable (e.g., as indicated to the SMF entity 506 by the UE 502), the SMF entity 506 may configure the network node 504 for ECN marking (which is described in more detail in connection with FIG. 5B). Similarly, in aspects in which the QoS flow has changed from ECN capable to ECN incapable (e.g., as indicated to the SMF entity 506 by the UE 502), the SMF entity 506 may de-configure the network node 504 for ECN marking.

Once a QoS flow has been identified and/or signaled as ECN capable, such as via the downlink procedures described above in connection with reference numbers 510-516 and/or via the uplink procedures described above in connection with reference numbers 518-524, one or more network entities may perform ECN marking on one or more packets associated with the QoS flow (e.g., one or more network entities may mark an ECN field of an IP header with a codepoint corresponding to an ECN status of the QoS flow). Aspects of marking an IP packet with ECN information is described in more detail below in connection with FIG. 5B.

More particularly, FIG. 5B shows procedures for ECN marking on the downlink (e.g., procedures for marking packets transmitted to the UE 502 on the Uu interface from the network node 504), and procedures for ECN marking on the uplink (e.g., procedures for marking packets transmitted by the UE 502 on the Uu interface to the network node 504).

As shown by reference number 526, the SMF entity 506 (e.g., a core network entity) may transmit (e.g., using communication manager 160, controller/processor 290, memory 292, communication unit 294, transmission component 1104, and/or configuration component 1108), and the UE 502 and/or the network node 504 (e.g., a RAN network entity) may receive (e.g., using communication manager 140, controller/processor 280, one or more antennas 252, one or more modems 254, MIMO detector 256, receive processor 258, memory 282, and/or reception component 902 associated with the UE 502, and/or communication manager 150, communication unit 244, controller/processor 240, one or more antennas 234, one or more modems 232, MIMO detector 236, receive processor 238, memory 242, and/or reception component 1002 associated with the network node 504), configuration information. In some aspects, the configuration information may include an indication of one or more configuration parameters (e.g., already known to the UE 502 and/or the network node 504 and/or previously indicated by the SMF entity 506 and/or another network entity) for selection by the UE 502 and/or the network node 504, and/or explicit configuration information for the UE 502 and/or the network node 504 to use to configure the UE 502 and/or the network node 504, among other examples.

In some aspects, the configuration information may indicate ECN marking criteria associated with ECN marking performed by the UE 502 and/or the network node 504 (e.g., a RAN network entity) on the uplink and/or the downlink. For example, in some aspects, the configuration information may indicate ECN marking criteria associated with a QoS flow (e.g., one of the QoS flows 410 described above in connection with FIG. 4) associated with an IP packet (e.g., one of the IP packets described above in connection with reference numbers 510 and 512). Additionally, or alternatively, in some aspects, the ECN marking criteria may include criteria associated with downlink transmissions (e.g., transmissions from the network node 504 to the UE 502 on the Uu interface) and/or certain criteria associated with uplink transmissions (e.g., transmissions from the UE 502 to the network node 504 on the Uu interface).

For example, the criteria associated with downlink transmissions may be associated with a metric associated with a delay between a time at which a PDU associated with an IP packet is received by the UE 502 from the network node 504 and a time at which the PDU associated with the IP packet is delivered to an SDAP layer of the UE 502 (sometimes referred to herein as a downlink delay metric). Put another way, for an SDAP service data unit (SDU) in an ECN-enabled QoS flow, the ECN marking criteria may be associated with a metric associated with a delay from a time when a MAC PDU (e.g., a PDU in which the SDAP SDU carrying an IP packet is multiplexed) is received by the UE 502 to a time when the SDAP SDU is successfully delivered to the SDAP layer of the UE 502. In such aspects, the criteria for performing ECN marking (e.g., the criteria for marking an ECN field of an IP packet with codepoint “11”) may include an average value of the downlink delay metric and/or a specific percentile (e.g., 90%) of the downlink delay metric exceeding a threshold (e.g., a time threshold).

In some other aspects, the criteria associated with downlink transmissions may be associated with a metric associated with a jitter of arrival times of SDAP SDUs, such as the jitter of arrival times at the UE 502 of SDAP SDUs associated with a periodic flow (sometimes referred to herein as a jitter metric). In such aspects, the criteria for performing ECN marking (e.g., the criteria for marking an ECN field of an IP packet with codepoint “11”) may include an average value of the jitter metric and/or a specific percentile (e.g., 90%) of the jitter metric exceeding a threshold (e.g., a time threshold).

In some other aspects, the criteria associated with downlink transmissions may be associated with a metric associated with a quantity of downlink PDUs that are discarded within a time window (sometimes referred to herein as a downlink discard metric). Put another way, the ECN marking criteria may be associated with a metric associated with a percentage of the downlink PDUs in an ECN enabled QoS flow that are discarded by the UE 502 in the time window. In some aspects, the downlink discard metric may be associated with a time filtered version of the percentage of the downlink PDUs in an ECN enabled QoS flow that are discarded by the UE 502 in the time window (e.g., a weighted exponential moving average of the loss measured in the last N time windows). In some aspects, discard may be based at least in part on a PDU exceeding its downlink delay budget (e.g., PDB). In some other aspects, discard may be based at least in part on a PDU becoming obsolete to an application. For example, a PDU may become obsolete to an application if the PDU is associated with a PDU set for which decoding is based on “all or nothing,” and one of the PDUs in the PDU set has been discarded. In some other examples, a PDU may become obsolete to an application if the PDU is associated with a PDU set which is FEC-protected and the application has received enough PDUs to successfully decode the PDU set. In such aspects, the criteria for performing ECN marking (e.g., the criteria for marking an ECN field of an IP packet with codepoint “11”) may include a percentage loss being higher than a threshold (e.g., a percentage threshold).

Additionally, or alternatively, the criteria associated with uplink transmissions may be associated with a metric associated with a delay between a time at which an SDAP SDU is received by an SDAP layer of the UE 502 and a time at which successful reception of the SDAP SDU is confirmed by a RLC status report received from the network node 504 (sometimes referred to herein as an uplink delay metric). In such aspects, the criteria for performing ECN marking (e.g., the criteria for marking an ECN field of an IP packet with codepoint “11”) may include an average value of the uplink delay metric and/or a specific percentile (e.g., 90%) of the uplink delay metric exceeding a threshold (e.g., a time threshold).

In some aspects, the criteria associated with uplink transmissions may be associated with a metric associated with a quantity of uplink PDUs that are discarded within a time window (sometimes referred to herein as an uplink discard metric). Put another way, the ECN marking criteria may be associated with a metric associated with a percentage of the uplink PDUs in an ECN enabled QoS flow that are discarded by the UE 502 in the time window. In some aspects, the uplink discard metric may be associated with a time filtered version of the percentage of the uplink PDUs in an ECN enabled QoS flow that are discarded by the UE 502 in the time window (e.g., a weighted exponential moving average of the loss measured in the last N time windows). In some aspects, discard may be based at least in part on a PDU exceeding its uplink delay budget (e.g., PDB). In some other aspects, discard may be based at least in part on a PDU becoming obsolete to an application (e.g., if decoding of a PDU set is based on “all or nothing” decoding and at least one of the PDUs in the PDU set has been discarded, if a PDU set is FEC protected and the application has received enough PDUs to successfully decode the PDU set, or similar scenarios). In such aspects, the criteria for performing ECN marking (e.g., the criteria for marking an ECN field of an IP packet with codepoint “11”) may include a percentage loss being higher than a threshold (e.g., a percentage threshold).

The UE 502 and/or the network node 504 (e.g., a RAN network entity) may configure themselves (e.g., using communication manager 140, controller/processor 280, and/or ECN component 910 associated with the UE 502, and/or communication manager 150, controller/processor 240, and/or ECN component 1008 associated with the network node 504) based at least in part on the configuration information. In some aspects, the UE 502 and/or the network node 504 may be configured to perform one or more operations described herein based at least in part on the configuration information. For example, based at least in part on the configuration information (e.g., the ECN marking criteria), one or more wireless communication devices may perform ECN marking on IP packets associated with an ECN-enable QoS flow. More particularly, reference numbers 528-532 show example procedures and/or signaling associated with the UE 502 performing ECN marking on IP packets on the downlink, reference number 534 shows example procedures and/or signaling associated with the UE 502 performing ECN marking on IP packets on the uplink, and reference numbers 536-540 show example procedures and/or signaling associated with the network node 504 (e.g., a RAN network entity) performing ECN marking on IP packets on the uplink.

More particularly, as shown by reference number 510 in FIG. 5B, the UPF entity 508 may receive (e.g., using communication manager 160, controller/processor 290, memory 292, communication unit 294, and/or reception component 1102) an IP flow including one or more IP packets (e.g., one or more IP packets described above in connection with reference number 420 in FIG. 4). As shown by reference number 528, the UPF entity 508 (e.g., a core network entity) may transmit (e.g., using communication manager 160, controller/processor 290, memory 292, communication unit 294, and/or transmission component 1104), and the network node 504 (e.g., a RAN network entity) may receive (e.g., using communication manager 150, communication unit 244, controller/processor 240, one or more antennas 234, one or more modems 232, MIMO detector 236, receive processor 238, memory 242, and/or reception component 1002), an IP packet associated with the IP flow. In some aspects, the UPF entity 508 may transmit the IP packet to the network node 504 via an N3 interface. Additionally, or alternatively, the UPF entity 508 may transmit the IP packet to the network node 504 via a QoS flow, such as one of the QoS flows 410 in FIG. 4.

As shown by reference number 530, the network node 504 (e.g., a RAN network entity) may transmit (e.g., using communication manager 150, communication unit 244, controller/processor 240, one or more antenna 234, one or more modems 232, transmit MIMO processor 230, transmit processor 220, memory 242, and/or transmission component 1004), and the UE 502 may receive (e.g., using communication manager 140, controller/processor 280, one or more antennas 252, one or more modems 254, MIMO detector 256, receive processor 258, memory 282, and/or reception component 902), the IP packet. In some aspects, the network node 504 may transmit the IP packet to the UE 502 via the Uu interface. Additionally, or alternatively, in some aspects, the network node 504 may transmit the IP packet to the UE 502 via an SDAP SDU.

As shown by reference number 532, the UE 502 may extract the IP packet, perform ECN marking on the IP packet, and/or update a checksum field associated with the IP packet (e.g., using communication manager 140, controller/processor 280, and/or ECN component 910). More particularly, upon receiving the SDAP SDU from the network node 504, the UE 502 may identify that the SDAP SDU and/or the IP packet is associated with a QFI which is ECN capable (which, in some aspects, may be signaled to the UE 502 and/or identified by the UE 502 using the operations described above in connection with FIG. 5A). Accordingly, the UE 502 may perform ECN marking on the IP packet when the UE 502 extracts the IP packet out of the SDAP SDU.

In some aspects, performing ECN marking may include the UE 502 detecting (e.g., using communication manager 140, controller/processor 280, and/or detection component 908), based at least in part on the ECN marking criteria described above in connection with reference number 526 (more particularly, based at least in part on the downlink ECN marking criteria), an ECN status associated with the QoS flow (e.g., the UE 502 may detect that at least some of the criteria associated with the downlink transmissions is satisfied), and the UE 502 marking (e.g., using communication manager 140, controller/processor 280, and/or the ECN component 910) the IP packet with ECN information based at least in part on the ECN status. In some aspects, the UE 502 may mark the IP packet with the ECN information by setting an ECN field in a header of the IP packet to a specified value. For example, the UE 502 may mark the IP packet with the ECN information by setting the ECN field in the header of the IP packet to a codepoint “11,” indicating that congestion has been experienced in the wireless network interface.

Moreover, in some aspects, the UE 502 may update a checksum field in a header of the IP packet based at least in part on marking the IP packet with the ECN information (e.g., the UE 502 may perform an incremental update of the checksum field). For example, in aspects in which the UE 502 marks the IP packet by changing the ECN field from a codepoint of “00” to “11,” the UE 502 may update the checksum filed in the header of the IP packet by changing corresponding bits in the checksum field from “00” to “11.”

In some aspects, ECN marking may be performed on the uplink. More particularly, reference numbers 534-540 show example procedures and/or signaling associated with performing ECN marking on IP packets on the uplink. In some aspects, indicated as “ECN UL making option 1” in FIG. 5B and shown in connection with reference number 534, the UE 502 may perform ECN marking in the uplink (e.g., an IP packet may be marked upon entering the Uu interface). In some other aspects, indicated as “ECN UL marking option 2” in FIG. 5B and shown in connection with reference numbers 536-540, the network node 504 (e.g., a RAN network entity) may perform ECN marking in the uplink (e.g., an IP packet may be marked upon exiting the Uu interface).

More particularly, in option 1 (e.g., marking an IP packet upon entering the Uu interface), the UE 502 may perform ECN marking (e.g., using communication manager 140, controller/processor 280, and/or ECN component 910) on IP packets when they are provided to a SDAP service access point. More particularly, as shown by reference number 534, upon receiving an IP flow including one or more IP packets (e.g., IP packets described above in connection with reference number 518), the UE 502 may identify (e.g., using communication manager 140, controller/processor 280, and/or identification component 912) that the IP packet is associated with a QFI which is ECN capable (which, in some aspects, may be signaled to the UE 502 and/or identified by the UE 502 using the operations described above in connection with FIG. 5A). Moreover, in some aspects, the UE 502 may detect (e.g., using communication manager 140, controller/processor 280, and/or detection component 908), based at least in part on the ECN marking criteria described above in connection with reference number 526 (more particularly, based at least in part on the uplink ECN marking criteria), an ECN status associated with the QoS flow (e.g., the UE 502 may detect that at least some of the criteria associated with uplink transmissions is satisfied), and the UE 502 may thus mark the IP packet with ECN information based at least in part on the ECN status. In some aspects, the UE 502 may mark the IP packet with the ECN information by setting an ECN field in a header of the IP packet to a specified value. For example, the UE 502 may mark the IP packet with the ECN information by setting the ECN field in the header of the IP packet to a codepoint “11,” indicating that congestion has been experienced in the wireless network interface.

Moreover, in some aspects, the UE 502 may update a checksum field in a header of the IP packet based at least in part on marking the IP packet with the ECN information (e.g., the UE 502 may perform an incremental update of the checksum field). For example, in aspects in which the UE 502 marks the IP packet by changes the ECN field from a codepoint of “00” to “11,” the UE 502 may update the checksum filed in the header of the IP packet by changing corresponding bits in the checksum field from “00” to “11.”

In option 2 (e.g., marking an IP packet upon exiting the Uu interface), the UE 502 may provide ECN status information of a QoS flow to the network node 504 (e.g., a RAN network entity) and the network node 504 may perform ECN marking when the network node 504 forwards IP packets in that QoS flow on an N3 interface. More particularly, as shown by reference number 536, when the UE 502 determines that ECN marking criteria for a QoS flow is satisfied (or else when ECN marking criteria for a QoS flow was satisfied, but is no longer satisfied), the UE 502 may transmit (e.g., using communication manager 140, controller/processor 280, one or more antennas 252, one or more modems 254, transmit MIMO processor 266, transmit processor 264, memory 282, and/or transmission component 904), and the network node 504 (e.g., a RAN network entity) may receive (e.g., using communication manager 150, communication unit 244, controller/processor 240, one or more antennas 234, one or more modems 232, MIMO detector 236, receive processor 238, memory 242, and/or reception component 1002), an indication of the ECN status (e.g., an indication that ECN marking criteria has been satisfied). For example, the UE 502 may detect, based at least in part on the ECN marking criteria described above in connection with reference number 526 (more particularly, based at least in part on the uplink ECN marking criteria), an ECN status associated with the QoS flow (e.g., the UE 502 may detect that at least some of the criteria associated with uplink transmissions is satisfied), and thus the UE 502 may transmit the indication shown in connection with reference number 536 to inform the network node 504 to perform ECN marking. In some aspects, the UE 502 may transmit the indication of the ECN status to the network node 504 via one of an SDAP PDU, a PDCP PDU, or an RLC PDU, among other examples. In some aspects, the indication may be transmitted in a new SDAP control PDU, a new PDCP control PDU, or a new RLC control PDU, while, in some other aspects, the indication may be transmitted one or more bits in a header of an existing SDAP PDU, an existing PDCP PDU, or an existing RLC PDU, such as an existing control or data PDU. For example, the UE 502 may transmit the indication using a reserved bit in an existing SDAP PDU, an existing PDCP PDU, or an existing RLC PDU which is repurposed for the indication. Additionally, or alternatively, the UE 502 may transmit the indication of the ECN status to the network node 504 via a MAC control element (MAC-CE). Moreover, the indication shown in connection with reference number 536 may include an indication of a QFI associated with the QoS flow. Put another way, the UE 502 may transmit to the network node 504 (e.g., a RAN network entity) an indication of ECN status information as well as the QFI of the QoS flow to which ECN marking should be applied.

As shown by reference number 538, when ECN is enabled for the QoS flow, the network node 504 (e.g., a RAN network entity) may extract the IP packet, perform ECN marking on the IP packet, and/or update a checksum field associated with the IP packet (e.g., using communication manager 150, controller/processor 240, and/or ECN component 1008). More particularly, upon receiving the SDAP SDU from the UE 502, the network node 504 may identify that the SDAP SDU and/or the IP packet is associated with a QFI which is ECN capable (which, in some aspects, may be signaled to the network node 504 using the operations described above in connection with FIG. 5A). Moreover, based at least in part on the indication described in connection with reference number 536, the network node 504 may perform ECN marking on the IP packet when the network node 504 extracts the IP packet out of the SDAP SDU. Put another way, the network node 504 may mark the IP packet with ECN information based at least in part on the ECN status received from the UE 502. In some aspects, the network node 504 may mark the IP packet with ECN information based at least in part on the ECN status information signaled to the network node 504 by the UE 502. In some aspects, the network node 504 may mark the IP packet with the ECN information by setting an ECN field in a header of the IP packet to a specified value. For example, the network node 504 may mark the IP packet with the ECN information by setting the ECN field in the header of the IP packet to a codepoint “11,” indicating that congestion has been experienced in the wireless network interface.

Moreover, in some aspects, the network node 504 (e.g., a RAN network entity) may update a checksum field in a header of the IP packet based at least in part on marking the IP packet with the ECN information (e.g., the network node 504 may perform an incremental update of the checksum field). For example, in aspects in which the network node 504 marks the IP packet by changing the ECN field from a codepoint of “00” to “11,” the network node 504 may update the checksum filed in the header of the IP packet by changing corresponding bits in the checksum field from “00” to “11.”

In some aspects, the network node 504 (e.g., a RAN network entity) may mark the IP packet with the ECN information prior to transmitting the IP packet on an N3 interface (e.g., the network node 504 may mark the IP packet upon exiting the Uu interface). More particularly, as shown by reference number 540, after marking the IP packet with the ECN information, the network node 504 may transmit (e.g., using communication manager 150, communication unit 244, controller/processor 240, one or more antenna 234, one or more modems 232, transmit MIMO processor 230, transmit processor 220, memory 242, and/or transmission component 1004), and the UPF entity 508 (e.g., a core network entity) may receive (e.g., using communication manager 160, controller/processor 290, memory 292, communication unit 294, and/or reception component 1102), the IP packet on the N3 interface. In some aspects, the network node 504 may transmit the IP packet to the UPF entity 508 using a general packet radio service (GPRS) tunneling protocol (GTP). For example, the network node 504 may transmit the IP packet to the UPF entity 508 by associating the IP packet with a GTP user plane (GTP-U) header (e.g., by encapsulating the IP packet with a GTP-U header).

Based at least in part on the UE 502, the network node 504 (e.g., a RAN network entity), the SMF entity 506 (e.g., a core network entity), and/or the UPF entity 508 (e.g., another core network entity) enabling ECN on a wireless network interface (e.g., the Uu interface), UE 502, the network node 504, the SMF entity 506, and/or the UPF entity 508 may conserve computing, power, network, and/or communication resources that may have otherwise been consumed entities sending and receiving packets without ECN information. For example, based at least in part on the UE 502, the network node 504, the SMF entity 506, and/or the UPF entity 508 enabling ECN on a wireless network interface, the UE 502, the network node 504, the SMF entity 506, and/or the UPF entity 508 may communicate with a reduction in dropped packets and/or a reduced error rate, which may conserve computing, power, network, and/or communication resources that may have otherwise been consumed to detect and/or correct communication errors.

As indicated above, FIGS. 5A-5B are provided as an example. Other examples may differ from what is described with respect to FIGS. 5A-5B.

FIG. 6 is a diagram illustrating an example process 600 performed, for example, by a UE, in accordance with the present disclosure. Example process 600 is an example where the UE (e.g., UE 502) performs operations associated with explicit congestion notification on a wireless network interface.

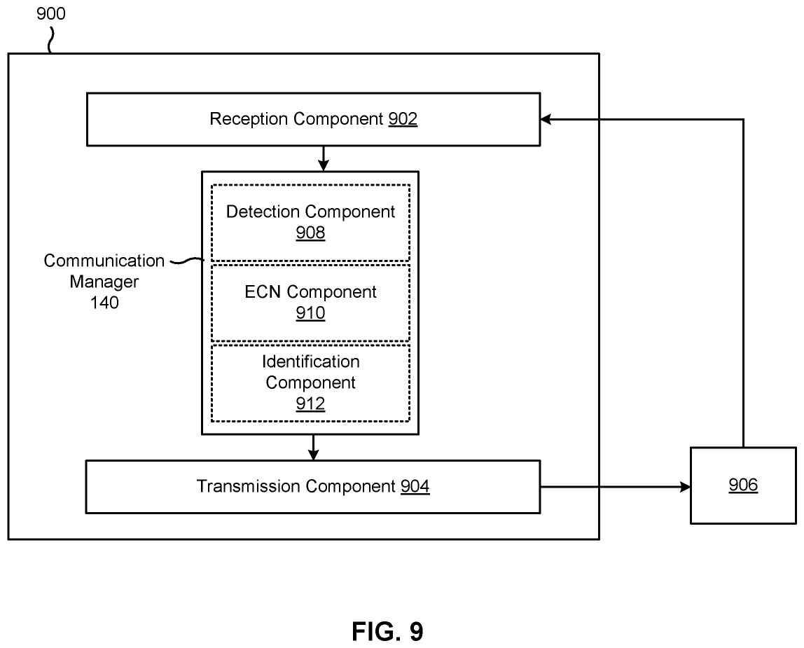

As shown in FIG. 6, in some aspects, process 600 may include receiving configuration information indicating ECN marking criteria associated with a QoS flow associated with an IP packet (block 610). For example, the UE (e.g., using communication manager 140 and/or reception component 902, depicted in FIG. 9) may receive configuration information indicating ECN marking criteria associated with a QoS flow associated with an IP packet, as described above.

As further shown in FIG. 6, in some aspects, process 600 may include detecting, based at least in part on the ECN marking criteria, an ECN status associated with the QoS flow (block 620). For example, the UE (e.g., using communication manager 140 and/or detection component 908, depicted in FIG. 9) may detect, based at least in part on the ECN marking criteria, an ECN status associated with the QoS flow, as described above.

As further shown in FIG. 6, in some aspects, process 600 may include performing one of: marking the IP packet with ECN information based at least in part on the ECN status, or transmitting an indication of the ECN status to a first network entity (block 630). For example, the UE (e.g., using communication manager 140 and/or ECN component 910, depicted in FIG. 9) may perform one of: marking the IP packet with ECN information based at least in part on the ECN status, or transmitting an indication of the ECN status to a first network entity, as described above.

Process 600 may include additional aspects, such as any single aspect or any combination of aspects described below and/or in connection with one or more other processes described elsewhere herein.

In a first aspect, process 600 includes receiving configuration information indicating at least one of the QoS flow is ECN capable, or an ECN capability of the QoS flow has changed. In a second aspect, alone or in combination with the first aspect, process 600 includes receiving the IP packet, identifying the QoS flow associated with the IP packet based at least in part on receiving the IP packet, and detecting the ECN status associated with the QoS flow based at least in part on header information associated with the IP packet. In a third aspect, alone or in combination with one or more of the first and second aspects, process 600 includes transmitting an indication of the ECN status to a second network entity based at least in part on the header information associated with the IP packet.

In a fourth aspect, alone or in combination with one or more of the first through third aspects, transmitting the indication of the ECN status to the second network entity is performed via NAS signaling. In a fifth aspect, alone or in combination with one or more of the first through fourth aspects, transmitting the indication of the ECN status to the second network entity is further based at least in part on at least one of identifying that the QoS flow is ECN capable, or identifying that an ECN capability of the QoS flow has changed.

In a sixth aspect, alone or in combination with one or more of the first through fifth aspects, the ECN marking criteria includes criteria associated with downlink transmissions, and the criteria associated with the downlink transmissions is associated with at least one of a metric associated with a delay between a time at which a PDU associated with the IP packet is received and a time at which the PDU associated with the IP packet is delivered to an SDAP layer, a metric associated with a jitter of arrival times of SDAP service data units associated with a periodic flow, or a metric associated with a quantity of downlink PDUs that are discarded within a time window. In a seventh aspect, alone or in combination with one or more of the first through sixth aspects, process 600 includes marking the IP packet with the ECN information based at least in part on receiving the IP packet via a downlink transmission, identifying that the QoS flow is ECN capable, and detecting that at least some of the criteria associated with the downlink transmissions is satisfied.

In an eighth aspect, alone or in combination with one or more of the first through seventh aspects, the ECN marking criteria includes criteria associated with uplink transmissions, and the criteria associated with the uplink transmissions is associated with at least one of a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window. In a ninth aspect, alone or in combination with one or more of the first through eighth aspects, process 600 includes marking the IP packet with the ECN information based at least in part on the IP packet being provided to an SDAP service access point. In a tenth aspect, alone or in combination with one or more of the first through ninth aspects, process 600 includes marking the IP packet with the ECN information by setting an ECN field in a header of the IP packet to a specified value.

In an eleventh aspect, alone or in combination with one or more of the first through tenth aspects, process 600 includes marking the IP packet with the ECN information, and updating a checksum field in a header of the IP packet based at least in part on marking the IP packet with the ECN information. In a twelfth aspect, alone or in combination with one or more of the first through eleventh aspects, process 600 includes transmitting the indication of the ECN status to the first network entity via one of an SDAP PDU, a packet data convergence protocol PDU, or a radio link control PDU. In a thirteenth aspect, alone or in combination with one or more of the first through twelfth aspects, process 600 includes transmitting the indication of the ECN status to the first network entity via a MAC control element. In a fourteenth aspect, alone or in combination with one or more of the first through thirteenth aspects, process 600 includes transmitting the indication of the ECN status to the first network entity, and transmitting an indication of a QoS flow identifier associated with the QoS flow to the first network entity.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., network node 504) performs operations associated with explicit congestion notification on a wireless network interface.

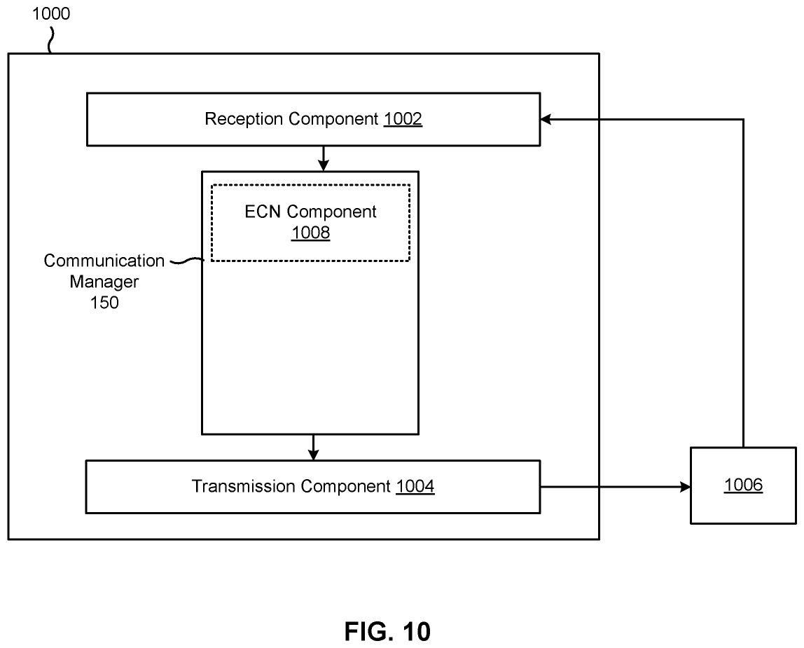

As shown in FIG. 7, in some aspects, process 700 may include receiving an indication of an ECN status associated with a QoS flow associated with an IP packet, the ECN status being based at least in part on ECN marking criteria associated with the QoS flow (block 710). For example, the network entity (e.g., using communication manager 150 and/or reception component 1002, depicted in FIG. 10) may receive an indication of an ECN status associated with a QoS flow associated with an IP packet, the ECN status being based at least in part on ECN marking criteria associated with the QoS flow, as described above.

As further shown in FIG. 7, in some aspects, process 700 may include marking the IP packet with ECN information based at least in part on the ECN status (block 720). For example, the network entity (e.g., using communication manager 150 and/or ECN component 1008, depicted in FIG. 10) may mark the IP packet with ECN information based at least in part on the ECN status, as described above.

Process 700 may include additional aspects, such as any single aspect or any combination of aspects described below and/or in connection with one or more other processes described elsewhere herein.

In a first aspect, process 700 includes receiving configuration information indicating an ECN capability of the QoS flow. In a second aspect, alone or in combination with the first aspect, the ECN marking criteria are associated with at least one of a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window. In a third aspect, alone or in combination with one or more of the first and second aspects, process 700 includes marking the IP packet with the ECN information prior to transmit the IP packet on an N3 interface.

In a fourth aspect, alone or in combination with one or more of the first through third aspects, process 700 includes transmitting the IP packet on the N3 interface based at least in part on associating the IP packet with a general packet radio service tunneling protocol user plane header. In a fifth aspect, alone or in combination with one or more of the first through fourth aspects, process 700 includes marking the IP packet with the ECN information by setting an ECN field in a header of the IP packet to a specified value. In a sixth aspect, alone or in combination with one or more of the first through fifth aspects, process 700 includes marking the IP packet with the ECN information, and updating a checksum field in a header of the IP packet based at least in part on marking the IP packet with the ECN information.

In a seventh aspect, alone or in combination with one or more of the first through sixth aspects, process 700 includes receiving the indication of the ECN status via one of an SDAP PDU, a packet data convergence protocol PDU, or a radio link control PDU. In an eighth aspect, alone or in combination with one or more of the first through seventh aspects, process 700 includes receiving the indication of the ECN status via a MAC control element. In a ninth aspect, alone or in combination with one or more of the first through eighth aspects, process 700 includes receiving an indication of a QoS flow identifier associated with the QoS flow.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., SMF entity 506 and/or UPF entity 508) performs operations associated with explicit congestion notification on a wireless network interface.

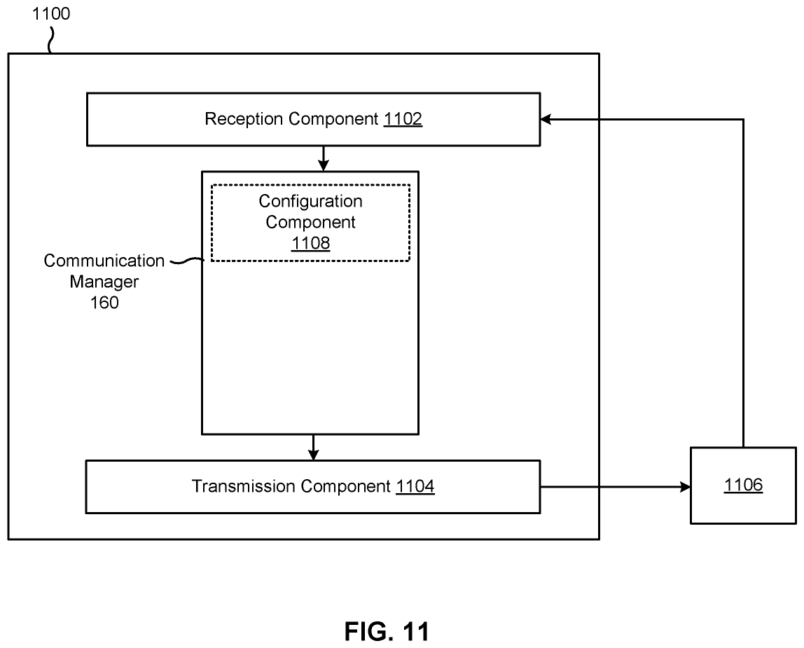

As shown in FIG. 8, in some aspects, process 800 may include transmitting configuration information indicating ECN marking criteria associated with a QoS flow associated with an IP packet (block 810). For example, the network entity (e.g., using communication manager 160, transmission component 1104, and/or configuration component 1108, depicted in FIG. 11) may transmit configuration information indicating ECN marking criteria associated with a QoS flow associated with an IP packet, as described above.

As further shown in FIG. 8, in some aspects, process 800 may include receiving an indication of an ECN status associated with the QoS flow based at least in part on the ECN criteria (block 820). For example, the network entity (e.g., using communication manager 160 and/or reception component 1102, depicted in FIG. 11) may receive an indication of an ECN status associated with the QoS flow based at least in part on the ECN criteria, as described above.

Process 800 may include additional aspects, such as any single aspect or any combination of aspects described below and/or in connection with one or more other processes described elsewhere herein.

In a first aspect, process 800 includes transmitting configuration information indicating at least one of the QoS flow is ECN capable, or an ECN capability of the QoS flow has changed. In a second aspect, alone or in combination with the first aspect, process 800 includes receiving the indication of the ECN status based at least in part on header information associated with the IP packet. In a third aspect, alone or in combination with one or more of the first and second aspects, the indication of the ECN status is received via NAS signaling.

In a fourth aspect, alone or in combination with one or more of the first through third aspects, the indication of the ECN status is further based at least in part on at least one of an identification that the QoS flow is ECN capable, or an identification that an ECN capability of the QoS flow has changed. In a fifth aspect, alone or in combination with one or more of the first through fourth aspects, the ECN marking criteria includes criteria associated with downlink transmissions, and the criteria associated with the downlink transmissions is associated with at least one of a metric associated with a delay between a time at which a PDU associated with the IP packet is received and a time at which the PDU associated with the IP packet is delivered to an SDAP layer, a metric associated with a jitter of arrival times of SDAP service data units associated with a periodic flow, or a metric associated with a quantity of downlink PDUs that are discarded within a time window. In a sixth aspect, alone or in combination with one or more of the first through fifth aspects, the ECN marking criteria includes criteria associated with uplink transmissions, and the criteria associated with the uplink transmissions is associated with at least one of a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window.

In a seventh aspect, alone or in combination with one or more of the first through sixth aspects, process 800 includes receiving the IP packet on an N3 interface, wherein the IP packet is associated with a general packet radio service tunneling protocol user plane header, and wherein the IP packet is marked with ECN information. In an eighth aspect, alone or in combination with one or more of the first through seventh aspects, the IP packet is marked with the ECN information via an ECN field in a header of the IP packet being set to a specified value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., UE 502), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a network node, or another wireless communication device) using the reception component 902 and the transmission component 904. As further shown, the apparatus 900 may include the communication manager 140. The communication manager 140 may include one or more of a detection component 908, an ECN component 910, or an identification component 912, among other examples.

In some aspects, the apparatus 900 may be configured to perform one or more operations described herein in connection with FIGS. 5A-5B. Additionally, or alternatively, the apparatus 900 may be configured to perform one or more processes described herein, such as process 600 of FIG. 6. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The reception component 902 may receive configuration information indicating ECN marking criteria associated with a QoS flow associated with an IP packet. The detection component 908 may detect, based at least in part on the ECN marking criteria, an ECN status associated with the QoS flow. The ECN component 910 may perform one of marking the IP packet with ECN information based at least in part on the ECN status, or transmitting an indication of the ECN status to a first network entity.

The reception component 902 may receive configuration information indicating at least one of the QoS flow is ECN capable, or an ECN capability of the QoS flow has changed. The reception component 902 may receive the IP packet.

The identification component 912 may identify the QoS flow associated with the IP packet based at least in part on receiving the IP packet. The detection component 908 may detect the ECN status associated with the QoS flow based at least in part on header information associated with the IP packet. The transmission component 904 may transmit an indication of the ECN status to a second network entity based at least in part on the header information associated with the IP packet.

The ECN component 910 may mark the IP packet with the ECN information based at least in part on receiving the IP packet via a downlink transmission, identifying that the QoS flow is ECN capable, and detecting that at least some of the criteria associated with the downlink transmissions is satisfied. The ECN component 910 may mark the IP packet with the ECN information based at least in part on the IP packet being provided to an SDAP service access point. The ECN component 910 may mark the IP packet with the ECN information by setting an ECN field in a header of the IP packet to a specified value. The ECN component 910 may mark the IP packet with the ECN information. The ECN component 910 may update a checksum field in a header of the IP packet based at least in part on marking the IP packet with the ECN information.

The transmission component 904 may transmit the indication of the ECN status to the first network entity via one of an SDAP PDU, a packet data convergence protocol PDU, or a radio link control PDU. The transmission component 904 may transmit the indication of the ECN status to the first network entity via a MAC control element. The transmission component 904 may transmit the indication of the ECN status to the first network entity. The transmission component 904 may transmit an indication of a QoS flow identifier associated with the QoS flow to the first network entity.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity (e.g., network node 504), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include the communication manager 150. The communication manager 150 may include an ECN component 1008, among other examples.

In some aspects, the apparatus 1000 may be configured to perform one or more operations described herein in connection with FIGS. 5A-5B. Additionally, or alternatively, the apparatus 1000 may be configured to perform one or more processes described herein, such as process 700 of FIG. 7. In some aspects, the apparatus 1000 and/or one or more components shown in FIG. 10 may include one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node 110 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node 110 described in connection with FIG. 2. In some aspects, the transmission component 1004 may be co-located with the reception component 1002 in a transceiver.

The reception component 1002 may receive an indication of an ECN status associated with a QoS flow associated with an IP packet, the ECN status being based at least in part on ECN marking criteria associated with the QoS flow. The ECN component 1008 may mark the IP packet with ECN information based at least in part on the ECN status.

The reception component 1002 may receive configuration information indicating an ECN capability of the QoS flow. The ECN component 1008 may mark the IP packet with the ECN information prior to transmitting the IP packet on an N3 interface. The transmission component 1004 may transmit the IP packet on the N3 interface based at least in part on associating the IP packet with a general packet radio service tunneling protocol user plane header.

The ECN component 1008 may mark the IP packet with the ECN information by setting an ECN field in a header of the IP packet to a specified value. The ECN component 1008 may mark the IP packet with the ECN information. The ECN component 1008 may update a checksum field in a header of the IP packet based at least in part on marking the IP packet with the ECN information.

The reception component 1002 may receive the indication of the ECN status via one of an SDAP PDU, a packet data convergence protocol PDU, or a radio link control PDU. The reception component 1002 may receive the indication of the ECN status via a MAC control element. The reception component 1002 may receive an indication of a QoS flow identifier associated with the QoS flow.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., SMF entity 506 and/or UPF entity 508), or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, or another wireless communication device) using the reception component 1102 and the transmission component 1104. As further shown, the apparatus 1100 may include the communication manager 160. The communication manager 160 may include a configuration component 1108, among other examples.

In some aspects, the apparatus 1100 may be configured to perform one or more operations described herein in connection with FIGS. 5A-5B. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the network controller 130 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network controller 130 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network controller 130 described in connection with FIG. 2. In some aspects, the transmission component 1104 may be co-located with the reception component 1102 in a transceiver.

The transmission component 1104 may transmit configuration information indicating ECN marking criteria associated with a QoS flow associated with an IP packet. The reception component 1102 may receive an indication of an ECN status associated with the QoS flow based at least in part on the ECN criteria.

The transmission component 1104 may transmit configuration information indicating at least one of the QoS flow is ECN capable, or an ECN capability of the QoS flow has changed. The reception component 1102 may receive the indication of the ECN status based at least in part on header information associated with the IP packet. The reception component 1102 may receive the IP packet on an N3 interface, wherein the IP packet is associated with a general packet radio service tunneling protocol user plane header, and wherein the IP packet is marked with ECN information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving configuration information indicating ECN marking criteria associated with a QoS flow associated with an IP packet; detecting, based at least in part on the ECN marking criteria, an ECN status associated with the QoS flow; and performing one of: marking the IP packet with ECN information based at least in part on the ECN status, or transmitting an indication of the ECN status to a first network entity.

Aspect 2: The method of Aspect 1, further comprising receiving configuration information indicating at least one of: the QoS flow is ECN capable, or an ECN capability of the QoS flow has changed.

Aspect 3: The method of any of Aspects 1-2, further comprising: receiving the IP packet; identifying the QoS flow associated with the IP packet based at least in part on receiving the IP packet; and detecting the ECN status associated with the QoS flow based at least in part on header information associated with the IP packet.

Aspect 4: The method of Aspect 3, further comprising transmitting an indication of the ECN status to a second network entity based at least in part on the header information associated with the IP packet.

Aspect 5: The method of Aspect 4, wherein transmitting the indication of the ECN status to the second network entity is performed via NAS signaling.

Aspect 6: The method of any of Aspects 4-5, wherein transmitting the indication of the ECN status to the second network entity is further based at least in part on at least one of: identifying that the QoS flow is ECN capable, or identifying that an ECN capability of the QoS flow has changed.

Aspect 7: The method of any of Aspects 1-6, wherein the ECN marking criteria includes criteria associated with downlink transmissions, wherein the criteria associated with the downlink transmissions is associated with at least one of: a metric associated with a delay between a time at which a PDU associated with the IP packet is received and a time at which the PDU associated with the IP packet is delivered to an SDAP layer, a metric associated with a jitter of arrival times of SDAP service data units associated with a periodic flow, or a metric associated with a quantity of downlink PDUs that are discarded within a time window.

Aspect 8: The method of any of Aspects 1-7, further comprising marking the IP packet with the ECN information based at least in part on: receiving the IP packet via a downlink transmission, identifying that the QoS flow is ECN capable, and detecting that at least some of the criteria associated with the downlink transmissions is satisfied.

Aspect 9: The method of any of Aspects 1-8, wherein the ECN marking criteria includes criteria associated with uplink transmissions, wherein the criteria associated with the uplink transmissions is associated with at least one of: a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window.

Aspect 10: The method of any of Aspects 1-9, further comprising marking the IP packet with the ECN information based at least in part on the IP packet being provided to an SDAP service access point.

Aspect 11: The method of any of Aspects 1-10, further comprising marking the IP packet with the ECN information by setting an ECN field in a header of the IP packet to a specified value.

Aspect 12: The method of any of Aspects 1-11, further comprising: marking the IP packet with the ECN information; and updating a checksum field in a header of the IP packet based at least in part on marking the IP packet with the ECN information.

Aspect 13: The method of any of Aspects 1-12, further comprising transmitting the indication of the ECN status to the first network entity via one of an SDAP PDU, a packet data convergence protocol PDU, or a radio link control PDU.

Aspect 14: The method of any of Aspects 1-13, further comprising transmitting the indication of the ECN status to the first network entity via a MAC control element.

Aspect 15: The method of any of Aspects 1-14, further comprising: transmitting the indication of the ECN status to the first network entity; and transmitting an indication of a QoS flow identifier associated with the QoS flow to the first network entity.

Aspect 16: A method of wireless communication performed by network entity, comprising: receiving an indication of an ECN status associated with a QoS flow associated with an IP packet, the ECN status being based at least in part on ECN marking criteria associated with the QoS flow; and marking the IP packet with ECN information based at least in part on the ECN status.

Aspect 17: The method of Aspect 16, further comprising receiving configuration information indicating an ECN capability of the QoS flow.

Aspect 18: The method of any of Aspects 16-17, wherein the ECN marking criteria are associated with at least one of: a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window.

Aspect 19: The method of any of Aspects 16-18, further comprising marking the IP packet with the ECN information prior to transmit the IP packet on an N3 interface.

Aspect 20: The method of Aspect 19, further comprising transmitting the IP packet on the N3 interface based at least in part on associating the IP packet with a general packet radio service tunneling protocol user plane header.

Aspect 21: The method of any of Aspects 16-20, further comprising marking the IP packet with the ECN information by setting an ECN field in a header of the IP packet to a specified value.

Aspect 22: The method of any of Aspects 16-21, further comprising: marking the IP packet with the ECN information; and updating a checksum field in a header of the IP packet based at least in part on marking the IP packet with the ECN information.

Aspect 23: The method of any of Aspects 16-22, further comprising receiving the indication of the ECN status via one of an SDAP PDU, a packet data convergence protocol PDU, or a radio link control PDU.

Aspect 24: The method of any of Aspects 16-23, further comprising receiving the indication of the ECN status via a MAC control element.

Aspect 25: The method of any of Aspects 16-24, further comprising receiving an indication of a QoS flow identifier associated with the QoS flow.

Aspect 26: A method of wireless communication performed by a network entity, comprising: transmitting configuration information indicating ECN marking criteria associated with a QoS flow associated with an IP packet; and receiving an indication of an ECN status associated with the QoS flow based at least in part on the ECN criteria.

Aspect 27: The method of Aspect 26, further comprising transmitting configuration information indicating at least one of: the QoS flow is ECN capable, or an ECN capability of the QoS flow has changed.

Aspect 28: The method of any of Aspects 26-27, further comprising receiving the indication of the ECN status based at least in part on header information associated with the IP packet.

Aspect 29: The method of any of Aspects 26-28, wherein the indication of the ECN status is received via NAS signaling.

Aspect 30: The method of any of Aspects 26-29, wherein the indication of the ECN status is further based at least in part on at least one of: an identification that the QoS flow is ECN capable, or an identification that an ECN capability of the QoS flow has changed.

Aspect 31: The method of any of Aspects 26-30, wherein the ECN marking criteria includes criteria associated with downlink transmissions, wherein the criteria associated with the downlink transmissions is associated with at least one of: a metric associated with a delay between a time at which a PDU associated with the IP packet is received and a time at which the PDU associated with the IP packet is delivered to an SDAP layer, a metric associated with a jitter of arrival times of SDAP service data units associated with a periodic flow, or a metric associated with a quantity of downlink PDUs that are discarded within a time window.

Aspect 32: The method of any of Aspects 26-31, wherein the ECN marking criteria includes criteria associated with uplink transmissions, wherein the criteria associated with the uplink transmissions is associated with at least one of: a metric associated with a delay between a time at which an SDAP SDU is received by an SDAP layer and a time at which successful reception of the SDAP SDU is confirmed by a radio link control status report, or a metric associated with a quantity of uplink PDUs that are discarded within a time window.

Aspect 33: The method of any of Aspects 26-32, further comprising receiving the IP packet on an N3 interface, wherein the IP packet is associated with a general packet radio service tunneling protocol user plane header, and wherein the IP packet is marked with ECN information.

Aspect 34: The method of Aspect 33, wherein the IP packet is marked with the ECN information via an ECN field in a header of the IP packet being set to a specified value.

Aspect 35: An apparatus for wireless communication at a device, comprising a processor; memory coupled with the processor; and instructions stored in the memory and executable by the processor to cause the apparatus to perform the method of one or more of Aspects 1-15.

Aspect 36: A device for wireless communication, comprising a memory and one or more processors coupled to the memory, the one or more processors configured to perform the method of one or more of Aspects 1-15.

Aspect 37: An apparatus for wireless communication, comprising at least one means for performing the method of one or more of Aspects 1-15.

Aspect 38: A non-transitory computer-readable medium storing code for wireless communication, the code comprising instructions executable by a processor to perform the method of one or more of Aspects 1-15.

Aspect 39: A non-transitory computer-readable medium storing a set of instructions for wireless communication, the set of instructions comprising one or more instructions that, when executed by one or more processors of a device, cause the device to perform the method of one or more of Aspects 1-15.

Aspect 40: An apparatus for wireless communication at a device, comprising a processor; memory coupled with the processor; and instructions stored in the memory and executable by the processor to cause the apparatus to perform the method of one or more of Aspects 16-25.

Aspect 41: A device for wireless communication, comprising a memory and one or more processors coupled to the memory, the one or more processors configured to perform the method of one or more of Aspects 16-25.

Aspect 42: An apparatus for wireless communication, comprising at least one means for performing the method of one or more of Aspects 16-25.

Aspect 43: A non-transitory computer-readable medium storing code for wireless communication, the code comprising instructions executable by a processor to perform the method of one or more of Aspects 16-25.

Aspect 44: A non-transitory computer-readable medium storing a set of instructions for wireless communication, the set of instructions comprising one or more instructions that, when executed by one or more processors of a device, cause the device to perform the method of one or more of Aspects 16-25.

Aspect 45: An apparatus for wireless communication at a device, comprising a processor; memory coupled with the processor; and instructions stored in the memory and executable by the processor to cause the apparatus to perform the method of one or more of Aspects 26-34.

Aspect 46: A device for wireless communication, comprising a memory and one or more processors coupled to the memory, the one or more processors configured to perform the method of one or more of Aspects 26-34.

Aspect 47: An apparatus for wireless communication, comprising at least one means for performing the method of one or more of Aspects 26-34.

Aspect 48: A non-transitory computer-readable medium storing code for wireless communication, the code comprising instructions executable by a processor to perform the method of one or more of Aspects 26-34.

Aspect 49: A non-transitory computer-readable medium storing a set of instructions for wireless communication, the set of instructions comprising one or more instructions that, when executed by one or more processors of a device, cause the device to perform the method of one or more of Aspects 26-34.

Aspect 50: A method of wireless communication performed by a user equipment (UE), comprising: receiving an internet protocol (IP) packet; identifying a quality of service (QOS) flow associated with the IP packet based at least in part on receiving the IP packet; detecting an uplink explicit congestion notification (ECN) status associated with the QoS flow based at least in part on header information associated with the IP packet; transmitting an indication of the uplink ECN status to a core network entity based at least in part on the header information associated with the IP packet; and performing one of: marking the IP packet with uplink ECN information based at least in part on uplink ECN criteria, or transmitting, to a radio access network (RAN) network entity, an indication that at least one of the uplink ECN criteria is met or that none of the uplink ECN criteria is met.

Aspect 51: The method of Aspect 50, wherein transmitting the indication of the uplink ECN status to the core network entity comprises transmitting the indication of the uplink ECN status to the core network entity via non-access stratum (NAS) signaling.

Aspect 52: The method of any of Aspects 50-51, wherein transmitting the indication of the uplink ECN status to the core network entity comprises: identifying that the QoS flow is ECN capable, or identifying that an ECN capability of the QoS flow has changed.

Aspect 53: The method of any of Aspects 51-52, further comprising marking the IP packet with the uplink ECN information, and wherein the uplink ECN criteria are associated with at least one of: a metric associated with a delay between a time at which a service data adaptation protocol (SDAP) service data unit (SDU) is received by an SDAP layer and a time at which successful reception of the SDAP SDU is confirmed by a radio link control status report, or a metric associated with a quantity of uplink PDUs that are discarded within a time window.

Aspect 54: The method of any of Aspects 50-53, further comprising marking the IP packet with the uplink ECN information based at least in part on the IP packet being provided to a service data adaptation protocol (SDAP) service access point.

Aspect 55: The method of any of Aspects 50-54, further comprising marking the IP packet with the uplink ECN information by setting an ECN field in a header of the IP packet to a specified value.

Aspect 56: The method of Aspect 55, further comprising updating a checksum field in the header of the IP packet based at least in part on marking the IP packet with the uplink ECN information.

Aspect 57: The method of any of Aspects 50-56, further comprising transmitting the indication that at least one of the uplink ECN criteria is met or that none of the uplink ECN criteria is met by: using one of a dedicated service data adaptation protocol (SDAP) control protocol data unit (PDU), a dedicated packet data convergence protocol (PDCP) control PDU, or a dedicated radio link control (RLC) control PDU, or updating a header of one of an SDAP PDU, a PDCP PDU, or an RLC PDU.

Aspect 58: The method of any of Aspects 50-57, further comprising transmitting the indication that at least one of the uplink ECN criteria is met or that none of the uplink ECN criteria is met via a medium access control (MAC) control element.

Aspect 59: The method of any of Aspects 50-58, further comprising: transmitting the indication that at least one of the uplink ECN criteria is met or that none of the uplink ECN criteria is met; and transmitting, to the RAN network entity, an indication of a QoS flow identifier associated with the QoS flow.

Aspect 60: A method of wireless communication performed by a core network entity, comprising: receiving, from a user equipment (UE), an indication of an uplink explicit congestion notification (ECN) status associated with a quality of service (QOS) flow associated with an internet protocol (IP) packet, wherein the uplink ECN status is based at least in part on header information associated with the IP packet; and transmitting, to a radio access network (RAN) network entity, configuration information indicating the uplink ECN status associated with the QoS flow associated with the IP packet.

Aspect 61: The method of Aspect 60, wherein the uplink ECN status indicates at least one of: the QoS flow is ECN capable, or an ECN capability of the QoS flow has changed.

Aspect 62: The method of any of Aspects 60-61, wherein receiving the indication of the uplink ECN status comprises receiving the indication of the uplink ECN status is received via non-access stratum (NAS) signaling.

Aspect 63: The method of any of Aspects 60-62, further comprising receiving, from the RAN network entity, the IP packet on an N3 interface, wherein the IP packet is associated with a general packet radio service tunneling protocol user plane header, and wherein the IP packet is marked with uplink ECN information.

Aspect 64: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 50-63.

Aspect 65: An apparatus for wireless communication at a device, the apparatus comprising one or more memories and one or more processors coupled to the one or more memories, the one or more processors configured to cause the device to perform the method of one or more of Aspects 50-63.

Aspect 66: An apparatus for wireless communication, the apparatus comprising at least one means for performing the method of one or more of Aspects 50-63.

Aspect 67: A non-transitory computer-readable medium storing code for wireless communication, the code comprising instructions executable by one or more processors to perform the method of one or more of Aspects 50-63.

Aspect 68: A non-transitory computer-readable medium storing a set of instructions for wireless communication, the set of instructions comprising one or more instructions that, when executed by one or more processors of a device, cause the device to perform the method of one or more of Aspects 50-63.

Aspect 69: A device for wireless communication, the device comprising a processing system that includes one or more processors and one or more memories coupled with the one or more processors, the processing system configured to cause the device to perform the method of one or more of Aspects 50-63.

Aspect 70: An apparatus for wireless communication at a device, the apparatus comprising one or more memories and one or more processors coupled to the one or more memories, the one or more processors individually or collectively configured to cause the device to perform the method of one or more of Aspects 50-63.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive an internet protocol (IP) packet;
identify a quality of service (QOS) flow associated with the IP packet based at least in part on receiving the IP packet;
detect an uplink explicit congestion notification (ECN) status associated with the QoS flow based at least in part on header information associated with the IP packet;
transmit an indication of the uplink ECN status to a core network entity based at least in part on the header information associated with the IP packet; and
perform one of:
mark the IP packet with uplink ECN information based at least in part on uplink ECN criteria, or
transmit, to a radio access network (RAN) network entity, an indication that at least one of the uplink ECN criteria is met or that none of the uplink ECN criteria is met.

2. The UE of claim 1, wherein the one or more processors, to transmit the indication of the uplink ECN status to the core network entity, are configured to transmit the indication of the uplink ECN status to the core network entity via non-access stratum (NAS) signaling.

3. The UE of claim 1, wherein the one or more processors, to transmit the indication of the uplink ECN status to the core network entity, are configured to at least one of:
identify that the QoS flow is ECN capable, or
identify that an ECN capability of the QoS flow has changed.

4. The UE of claim 1, wherein the one or more processors are further configured to the mark the IP packet with the uplink ECN information, and
wherein the uplink ECN criteria are associated with at least one of:
a metric associated with a delay between a time at which a service data adaptation protocol (SDAP) service data unit (SDU) is received by an SDAP layer and a time at which successful reception of the SDAP SDU is confirmed by a radio link control status report, or
a metric associated with a quantity of uplink PDUs that are discarded within a time window.

5. The UE of claim 1, wherein the one or more processors are further configured to mark the IP packet with the uplink ECN information based at least in part on the IP packet being provided to a service data adaptation protocol (SDAP) service access point.

6. The UE of claim 1, wherein the one or more processors are further configured to mark the IP packet with the uplink ECN information by setting an ECN field in a header of the IP packet to a specified value.

7. The UE of claim 6, wherein the one or more processors are further configured to update a checksum field in the header of the IP packet based at least in part on marking the IP packet with the uplink ECN information.

8. The UE of claim 1, wherein the one or more processors are further configured to transmit the indication that at least one of the uplink ECN criteria is met or that none of the uplink ECN criteria is met by:
using one of a dedicated service data adaptation protocol (SDAP) control protocol data unit (PDU), a dedicated packet data convergence protocol (PDCP) control PDU, or a dedicated radio link control (RLC) control PDU, or
updating a header of one of an SDAP PDU, a PDCP PDU, or an RLC PDU.

9. The UE of claim 1, wherein the one or more processors are further configured to transmit the indication that at least one of the uplink ECN criteria is met or that none of the uplink ECN criteria is met via a medium access control (MAC) control element.

10. The UE of claim 1, wherein the one or more processors are further configured to:
transmit the indication that at least one of the uplink ECN criteria is met or that none of the uplink ECN criteria is met; and
transmit, to the RAN network entity, an indication of a QoS flow identifier associated with the QoS flow.

11. A core network entity for wireless communication, comprising:
one or more memories; and
one or more processors, coupled to the one or more memories, configured to:
receive, from a user equipment (UE), an indication of an uplink explicit congestion notification (ECN) status associated with a quality of service (QOS) flow associated with an internet protocol (IP) packet, wherein the uplink ECN status is based at least in part on header information associated with the IP packet; and
transmit, to a radio access network (RAN) network entity, configuration information indicating the uplink ECN status associated with the QoS flow associated with the IP packet.

12. The core network entity of claim 11, wherein the uplink ECN status indicates at least one of:
the QoS flow is ECN capable, or
an ECN capability of the QoS flow has changed.

13. The core network entity of claim 11, wherein the one or more processors, to receive the indication of the uplink ECN status, are configured to receive the indication of the uplink ECN status is received via non-access stratum (NAS) signaling.

14. The core network entity of claim 11, wherein the uplink ECN status is associated with at least one of:
a metric associated with a delay between a time at which a service data adaptation protocol (SDAP) service data unit (SDU) is received by an SDAP layer and a time at which successful reception of the SDAP SDU is confirmed by a radio link control status report, or
a metric associated with a quantity of uplink PDUs that are discarded within a time window.

15. The core network entity of claim 11, wherein the one or more processors are further configured to receive, from the RAN network entity, the IP packet on an N3 interface, wherein the IP packet is associated with a general packet radio service tunneling protocol user plane header, and wherein the IP packet is marked with uplink ECN information.

16. The core network entity of claim 15, wherein the IP packet is marked with the uplink ECN information via an ECN field in a header of the IP packet being set to a specified value.

17. A method of wireless communication performed by a user equipment (UE), comprising:
receiving an internet protocol (IP) packet;
identifying a quality of service (QOS) flow associated with the IP packet based at least in part on receiving the IP packet;
detecting an uplink explicit congestion notification (ECN) status associated with the QoS flow based at least in part on header information associated with the IP packet;
transmitting an indication of the uplink ECN status to a core network entity based at least in part on the header information associated with the IP packet; and
performing one of:
marking the IP packet with uplink ECN information based at least in part on uplink ECN criteria, or
transmitting, to a radio access network (RAN) network entity, an indication that at least one of the uplink ECN criteria is met or that none of the uplink ECN criteria is met.

18. The method of claim 17, wherein transmitting the indication of the uplink ECN status to the core network entity comprises transmitting the indication of the uplink ECN status to the core network entity via non-access stratum (NAS) signaling.

19. The method of claim 17, wherein transmitting the indication of the uplink ECN status to the core network entity comprises:
identifying that the QoS flow is ECN capable, or
identifying that an ECN capability of the QoS flow has changed.

20. The method of claim 17, further comprising marking the IP packet with the uplink ECN information,
wherein the uplink ECN criteria are associated with at least one of:
a metric associated with a delay between a time at which a service data adaptation protocol (SDAP) service data unit (SDU) is received by an SDAP layer and a time at which successful reception of the SDAP SDU is confirmed by a radio link control status report, or
a metric associated with a quantity of uplink PDUs that are discarded within a time window.
